(19) United States
(12) Patent Application Publication
(10) Pub. No.: US 2026/0360736 A1
(43) Pub. Date: Nov. 12, 2026

(54) BATTERY CELL, BATTERY APPARATUS, ELECTRICAL APPARATUS AND ENERGY STORAGE APPARATUS

(71) Applicant: CONTEMPORARY AMPEREX TECHNOLOGY CO., LIMITED, Ningde (CN)

(72) Inventors: Jia Li, Ningde (CN); Xiaoyang Jia, Ningde (CN); Xinde Ye, Ningde (CN); Xiaofeng Zhang, Ningde (CN); Song Li, Ningde (CN); Tianyue Yuan, Ningde (CN)

(21) Appl. No.: 19/676,837

(22) Filed: May 14, 2026

Related U.S. Application Data
(63) Continuation of application No. PCT/CN2025/109641, filed on Jul. 21, 2025.

(30) Foreign Application Priority Data
May 12, 2025 (WO) PCT/CN2025/094369

(51) Int. Cl. H01M 4/58; H01M 4/02; H01M 4/136; H01M 4/36; H01M 4/587; H01M 4/62; H01M 10/0583; H01M 50/105; H01M 50/122; H01M 50/131; H01M 50/211; H01M 50/242; H01M 50/434; H01M 50/491; H01M 50/586

(52) U.S. Cl. CPC H01M 4/5825; H01M 4/136; H01M 4/366; H01M 4/587; H01M 4/622; H01M 4/625; H01M 10/0583; H01M 50/105; H01M 50/122; H01M 50/131; H01M 50/211; H01M 50/242; H01M 50/434; H01M 50/491; H01M 50/586; H01M 2004/021; H01M 2004/028

(57) ABSTRACT

A battery cell, a battery apparatus, an electrical apparatus, and an energy storage apparatus. The battery cell includes a stacked-type cell. A positive electrode plate includes a positive electrode current collector main body part, a positive electrode tab, and positive electrode active material layers. Each positive electrode active material layer includes a main body region and a thinned region on a side close to the positive electrode tab, the thinned region having a smaller thickness than the main body region. The positive electrode active material includes lithium-containing transition metal phosphate particles with at least partially carbon-coated surfaces. When fully discharged, a single-side thickness H of the main body region is 70-120 μm. In a cross-section along the thickness direction, particles having a size R1 of 50-400 nm account for 10.0%-35.0% of total particle area, and LA50 in a sphericity-area cumulative distribution curve is 0.6-0.8.

### CROSS-REFERENCE TO RELATED APPLICATIONS

The present application is a continuation of International Application No. PCT/CN2025/109641, filed on Jul. 21, 2025, which claims priority to Chinese Patent Application PCT/CN2025/094369, entitled “BATTERY CELL, BATTERY APPARATUS, ELECTRICAL APPARATUS AND ENERGY STORAGE APPARATUS” filed on May 12, 2025, which is incorporated by reference in the present application.

### TECHNICAL FIELD

The present application relates to the technical field of batteries, and specifically relates to a battery cell, a battery apparatus, an electrical apparatus and an energy storage apparatus.

### BACKGROUND

In recent years, battery cells have been widely used in energy storage power systems such as hydropower, thermal power, wind power, and solar power plants, as well as in power tools, electric bicycles, electric motorcycles, electric vehicles, military equipment, aerospace and other fields.

With the double improvement of the market demand for the cruising range and safety performance of electrical apparatus, higher requirements are also put forward for the capacity and safety performance of the battery cells. However, it is difficult to achieve simultaneous improvement of the above performances in related technology, which has become a technical problem that needs to be solved urgently in this field.

### SUMMARY

In view of above, an objective of the present application is to provide a battery cell with high energy density, good cycle performance and safety.

In a first aspect, the present application provides a battery cell, which includes a stacked type cell; the stacked type cell includes a positive electrode plate, a separator and a negative electrode plate which are sequentially stacked; the positive electrode plate includes a positive electrode current collector main body part, a positive electrode tab and positive electrode active material layers; the positive electrode active material layers are arranged on two sides of the positive electrode current collector main body part along a thickness direction of the battery cell; the positive electrode tab is arranged on at least one side of the positive electrode current collector main body part; each positive electrode active material layer includes a main body region, and a thinned region arranged on the side, close to the positive electrode tab, of the main body region; a thickness of each thinned region is less than that of each main body region; each positive electrode active material layer includes a positive electrode active material; each positive electrode active material includes lithium-containing transition metal phosphate particles of which at least part of surfaces are provided with a carbon material; when the battery cell is in a full-discharge state, a single-side thickness H of each positive electrode active material layer is 70-120 μm; an area proportion of particles with a particle size R1 meeting 50 nm≤R1≤400 nm is 10.0%-35.0% based on the total area of particles in a section of each positive electrode active material layer 11 along the thickness direction of the battery cell; and in the section of each positive electrode active material layer along the thickness direction of the battery cell, LA50 in a cumulative distribution curve of sphericity area of the particles is 0.6-0.8.

According to embodiment of the present application, the battery cell relives the problems of current leakage and lithium precipitation, and meets the cycle life and safety performance while high capacity is ensured.

It is not bound by any theory, which may be because that: a stacked type cell structure can reduce an invalid space inside the battery cell, effectively eliminate inevitable corner gaps and interlayer gaps in a winding process, and make the entire cell structure more compact, thereby improving space utilization, improving the volume energy density of the battery cell, and increasing the battery capacity; in addition, the single-side thickness H of the main body is 70-120 μm, so it has a high active material load, which further improves the energy density of the battery.

In addition, film slurry of the battery is a non-Newtonian fluid which has rheological properties, including shear thinning and thixotropy. When the slurry is used for coating, a viscosity of the slurry decreases significantly when it is subjected to shear force (shear thinning), which is conducive to reducing the resistance during coating and achieving good surface flatness; after coating, the viscosity of the slurry gradually recovers (thixotropy) as the shear force is removed, resulting in a thinned region. Appropriate thixotropy helps to inhibit lateral diffusion after slurry coating, thus improving the size consistency of the thinned region at a coating boundary. In the thick-coated process, a single-side coating density of the slurry increases, and under the action of gravity, the thinned region of its edge is more likely to have uneven diffusion, resulting in alignment deviation. Therefore, it is of great significance to optimize the rheological characteristics of the slurry, which can help to enhance the film-forming consistency in the coating and drying processes and reduce the diffusion of the slurry, and further inhibit the alignment deviation caused by the deformation of a film layer.

Research shows that small particles in the slurry in the film layer had a significant impact on the rheological behavior of the slurry. The small particles are not easy to settle, which helps to improve the stability of the slurry; a colloid formed by agglomeration of the slurry helps to improve an initial viscosity, and disperses under the shear force, showing a shear thinning behavior, and after removing the shear force, it has appropriate thixotropy, and the small particles will be re-agglomerated into colloids, which helps to quickly restore the viscosity and limit the transitional diffusion of slurry. However, if there are too many small particles in the slurry, it may cause the slurry to gel, making the slurry viscosity too large, thus affecting the coating process. In addition, a roundness of the particles also significantly affects the rheological behavior of the slurry, and the colloids formed by high-sphericity particles are more easily dispersed under the shear force, which helps to enhance their shear thinning characteristics and improve the fluidity of the slurry. In the embodiment of the present application, the area proportion of the particles with the particle size R1 meeting 50 nm≤R1≤400 nm is 10%-35% based on the total area of the particles in the section of each positive electrode active material layer along the thickness direction of the battery cell; and in the section of each positive electrode active material layer along the thickness direction of the battery cell, LA50 in the cumulative distribution curve of sphericity area of the particles is 0.6-0.8, which helps to achieve good shear thinning characteristics and appropriate thixotropy of the positive electrode slurry, thereby reducing the difference in the thinned region in a positive electrode film layer in a thick-coated electrode plate, reducing the alignment deviation, reducing the probability of leakage of the current collector, improving space utilization, and reducing the lithium precipitation probability on the negative electrode side, and further improving the volume energy density of the battery while ensuring the safety performance and cycle performance.

In some embodiments, when the battery cell is in the full-discharge state, the single-side thickness H of the main body region is 90-120 μm.

In some embodiments, when the battery cell is in the full-discharge state, the single-side thickness H of the main body region is 100-120 μm.

Increasing the thickness of the positive electrode active material layer helps to increase the load of the active substance and increase the capacity of the battery. However, the applicant found that as the single-side thickness of the positive electrode active material layer increased, the alignment deviation further increased, which exacerbated the problems of leakage of the current collector and lithium precipitation, and further affected the cycle performance and safety performance of the battery cell. In the embodiment of the present application, the battery cell includes the stacked type cell, and the stacked type cell includes the positive electrode plate, the separator and the negative electrode plate which are sequentially stacked; the positive electrode plate includes the positive electrode current collector main body part, the positive electrode tab and the positive electrode active material layers; the positive electrode active material layers are arranged on two sides of the positive electrode current collector main body part along the thickness direction of the battery cell; the positive electrode tab is arranged on at least one side of the positive electrode current collector main body part; each positive electrode active material layer includes the main body region, and the thinned region arranged on the side, close to the positive electrode tab, of the main body region; the thickness of each thinned region is less than that of each main body region; each positive electrode active material layer includes the positive electrode active material; each positive electrode active material includes the lithium-containing transition metal phosphate particles of which at least part of surfaces are provided with a carbon material; when the battery cell is in the full-discharge state, the single-side thickness H of each positive electrode active material layer is 70-120 μm; the area proportion of the particles with the particle size R1 meeting 50 nm≤R1≤400 nm is 10.0%-35.0% based on the total area of particles in the section of each positive electrode active material layer along the thickness direction of the battery cell; and in the section of each positive electrode active material layer along the thickness direction of the battery cell, LA50 in the cumulative distribution curve of sphericity area of the particles is 0.6-0.8, which is conducive to further improving the capacity of the battery cell, while reducing the probability of leakage of the current collector and lithium precipitation, ensuring the energy density, cycle performance and safety performance of the battery cell.

In some embodiments, in the section of each positive electrode active material layer along the thickness direction of the battery cell, LA50 in the cumulative distribution curve of sphericity area of the particles is 0.65-0.75.

In some embodiments, in the section of each positive electrode active material layer along the thickness direction of the battery cell, LA50 in the cumulative distribution curve of sphericity area of the particles is 0.67-0.72.

A sphericity of the particles in the positive electrode active material layer is further within the above range, which is conducive to reducing the alignment deviation, reducing the risks of leakage of the current collector and lithium precipitation, thereby further improving the cycle performance and safety performance on the basis of improving the energy density of the battery cell.

In some embodiments, projections of edges, far away from the main body regions, of two thinned regions on two sides of the positive electrode current collector main body part in the thickness direction of the battery cell on the positive electrode current collector main body part are A and B respectively, and the minimum distance E from A to B is 0.1-0.6 mm.

In the embodiments of the present application, the single-side thickness H of the main body region is 70-120 μm; the area proportion of particles with the particle size R1 meeting 50 nm≤R1≤400 nm is 10%-35.0% based on the total area of the particles in the section of each main body region along the thickness direction of the battery cell; and in the section of each positive electrode active material layer along the thickness direction of the battery cell, LA50 in the cumulative distribution curve of sphericity area of the particles is 0.6-0.8, which is conducive to further improving consistency of the thinned region and reducing the alignment deviation into the above range, thereby improving the capacity of the battery cell, while reducing the probability of leakage of the current collector and lithium precipitation, ensuring the cycle performance and safety performance of the battery cell.

In some embodiments, the projections of the edges, far away from the main body regions, of two thinned regions on two sides of the positive electrode current collector main body part in the thickness direction of the battery cell on the positive electrode current collector main body part are A and B respectively, and the minimum distance E from A to B is 0.1-0.4 mm.

In the embodiments of the present application, the alignment deviation is further within the above range, which is conducive to further reducing the probability of leakage of the current collector and lithium precipitation, ensuring the cycle performance and safety performance of the battery cell.

In some embodiments, the area proportion of particles with the particle size R2 meeting R2≥1000 nm is 12%-30% based on the total area of the particles in the section of each positive electrode active material layer along the thickness direction of the battery cell.

The uniformity of slurry remarkably influences the shear thinning characteristic and thixotropy of the slurry. The inventor found that large particles with the particle size R2 meeting R2≥1000 nm in positive electrode slurry are easy to settle, which affects the uniformity of the slurry; in the embodiment of the present application, the area proportion of the particles with the particle size R2 meeting R2≥1000 nm is within the above range, which is conducive to improving a compaction density of the film layer and improving the capacity of a battery on one hand; and on the other hand, the particle proportion is not too high, which helps to ensure the uniformity of the slurry, makes the slurry have good shear thinning characteristic and proper thixotropy, thereby improving the capacity of the battery while reducing the alignment deviation, reducing the probability of leakage of the current collector and lithium precipitation, and ensuring good cycle performance and safety performance.

In some embodiments, in the section of each positive electrode active material layer along the thickness direction of the battery cell, a distribution uniformity of the particles with the particle size R2 meeting R2≥1000 nm is less than and equal to 5.0%.

In the positive electrode active material layers, the distribution uniformity of the particles with the particle size R2 meeting R2≥1000 nm is within the above range, which indicates that the particles are uniformly distributed in the positive electrode slurry, namely the uniformity of the slurry is good, the slurry has good shear thinning characteristic and proper thixotropy, therefore, the alignment deviation is reduced, the probability of leakage of the current collector and lithium precipitation is reduced, and the cycle performance and safety performance of the battery cell are further improved.

In some embodiments, in the section of each positive electrode active material layer along the thickness direction of the battery cell, the distribution uniformity of the particles with the particle size R2 meeting R2≥1000 nm is 0.2%-2.5%.

In some embodiments, in the section of each positive electrode active material layer along the thickness direction of the battery cell, the distribution uniformity of the particles with the particle size R2 meeting R2≥1000 nm is 0.2%-2%.

In the section of each positive electrode active material layer along the thickness direction of the battery cell, the distribution uniformity of the particles with the particle size R2 meeting R2≥1000 nm is 0.2%-2.5%, further, 0.2%-2%, which is conducive to further reduce the alignment deviation, reduce the probability of leakage of the current collector and lithium precipitation, thereby further improving the cycle performance and safety performance of the battery.

In some embodiments, each positive electrode active material layer further includes a binder, and the binder includes a dispersant which includes hydrogenated nitrile butadiene rubber (HNBR).

The HNBR is obtained by performing hydrogenation saturation on double bonds of nitrile butadiene rubber, and its highly saturated backbone structure ensures its excellent oil resistance, heat resistance, and aging resistance. This allows it to remain stable in different environments and systems when used as the dispersant, and is not prone to degradation or deterioration, thereby effectively exerting its dispersing effect. An HNBR molecular chain contains both polar nitrile and non-polar hydrocarbon segments. Polar nitrile groups can interact with some polar substances or particle surfaces, such as adsorbed on the surfaces of dispersed particles by hydrogen binding and electrostatic action; the non-polar hydrocarbon chain segments have good lipophilicity, which can stretch and disperse well in non-polar or weakly polar media, so that the particles are evenly dispersed in the medium. When the HNBR is adsorbed on the surfaces of the particles in the slurry, its long chain molecules will form a physical barrier around the particles, preventing the particles from approaching and aggregating with each other, so that the particles remain relatively independent in a system. Moreover, the HNBR can reduce a surface tension between the dispersed medium and the dispersed particles, making the particles more easily wetted by the medium, thereby promoting the dispersion of particles in the medium. Moreover, it can also reduce the interfacial energy between the particles, reduce the aggregation phenomenon caused by an interfacial energy drive, and improve the uniformity of the slurry. In the embodiment of the present application, the positive electrode active material layer includes the dispersant that is the hydrogenated nitrile rubber (HNBR), which helps to improve the uniformity of the slurry, thereby further reducing the alignment deviation, reducing the risk of leakage of the current collector and lithium precipitation, and ensuring good cycling performance and safety performance while improving the capacity of the battery cell.

In some embodiments, based on the total mass of the positive electrode active material layers, a mass content of the dispersant is 0.5%-2%.

The mass content of the dispersant is within the above range, which is conducive to improve the uniformity of the slurry, thereby further reducing the alignment deviation, reducing the risks of leakage of the current collector and lithium precipitation, and ensuring good cycling performance and safety performance while improving the capacity of the battery cell.

In some embodiments, the positive electrode active material layer further includes a conductive agent, and based on the total area of the positive electrode active material layers in the thickness direction of the battery cell, the area proportion of an agglomeration region of the conductive agent is 0.5%-20.5%.

Based on the total area of the positive electrode active material layers along the thickness direction of the battery cell, the area proportion of the agglomeration region of the conductive agent is within the above range, which indicates that the positive electrode slurry has good uniformity, it is conducive to reducing the alignment deviation, reducing the risks of leakage of the current collector and lithium precipitation, and ensuring good cycling performance and safety performance while improving the capacity of the battery cell on one hand; and on the other hand, it indicates that the conductive agent in the positive electrode active material layer is uniformly dispersed, which is easy to form a uniform conductive network, it is particularly conducive to reducing the problem of dynamics reduction caused by increase of an ion transmission path of a thick-coated film layer, reducing the problems of local polarization and even lithium precipitation of the battery in the cycle process, thereby further prolonging the cycle life of the battery.

In some embodiments, the positive electrode active material layer further includes the conductive agent, and based on the total area of the positive electrode active material layers in the thickness direction of the battery cell, the area proportion of an agglomeration region of the conductive agent is 1.5%-20.5%.

In the embodiment of the present application, the area proportion of the agglomeration region of the conductive agent is further within the above range, which indicates that the conductive agent is more uniformly distributed in the positive electrode active material layer; and the content of the conductive agent is relatively low, which helps to reduce the occupied space of the positive electrode active material due to excessive conductive agent, thereby ensuring good cycle performance, safety performance, dynamics performance and volume energy density of the battery.

In some embodiments, the conductive agent includes carbon nanotubes which include one or more of a single-walled carbon nanotube, a few-walled carbon nanotube and a multi-walled carbon nanotube.

The carbon nanotubes have a one-dimensional structure, so that a network structure can be formed in the positive electrode active material layers. On one hand, the network structure is favorable for dispersing the particles in slurry, thereby improving the uniformity of the slurry, reducing the alignment deviation, reducing the risks of leakage of the current collector and lithium precipitation, further improving the capacity of the battery and ensuring good cycle performance and safety performance; and on the other hand, the network structure becomes an efficient electron transmission channel due to the excellent conductivity of the carbon nanotubes, so that the electron transmission rate of the thick-coated electrode plate in the thickness direction is increased, and the dynamics performance of the battery is improved.

In some embodiments, the conductive agent also includes the conductive carbon black.

In some embodiments, the agglomeration region of the conductive agent includes the carbon nanotubes and conductive carbon black.

Researchers found that the carbon nanotubes are prone to agglomeration due to high surface energy, resulting in uneven dispersion in the positive electrode active material layer, and inability to form an effective carbon nanotube network structure. The surface energy of the conductive carbon black is close to that of the carbon nanotubes, so the conductive carbon black can be adsorbed on the surfaces of the carbon nanotubes to form a physical barrier, which increases the agglomeration resistance of the carbon nanotubes, reduces direct contact among the carbon nanotubes, thus inhibiting the agglomeration phenomenon, and improving the distribution uniformity of the carbon nanotubes in the positive electrode active material layer. On one hand, it is conducive to improving the conductivity of the thick-coated positive electrode active material layer, and improving the dynamics performance of the battery; and on the other hand, it is conducive to playing the dispersion effect of a three-dimensional network structure of the carbon nanotubes on the particles in the positive electrode active material layers, reducing the alignment deviation, and thereby further improving the capacity, the cycle performance and the safety performance of the battery. In addition, the agglomeration of the carbon nanotubes in the agglomeration region of the conductive agent may cause blockage of the local ion transmission path of the agglomeration region of the conductive agent, and the conductive carbon black is matched to use, which can improve the lithium ion transmission capacity in this region, reduce local polarization, thereby further improving the cycle stability of the battery.

In any embodiment, based on the total mass of the positive electrode active material layer, a mass content C1 of the carbon nanotubes meets: 0<C1≤2.5%, and a mass content C2 of the conductive carbon black meets: 0<C2≤2.5%.

The mass content of the carbon nanotubes and the mass content of the conductive carbon black are within the above range, so that the agglomeration phenomenon of the carbon nanotubes can be effectively relieved and a good conductive network structure can be formed, thereby reducing the alignment deviation, improving the capacity of the battery and ensuring the cycle performance and the safety performance.

In some embodiments, when the battery cell is in the full-discharge state, a single-side surface density of the positive electrode active material layers is 0.25 g/1540.25 mm2-0.45 g/1540.25 mm2.

In some embodiments, when the battery cell is in the full-discharge state, the single-side surface density of the positive electrode active material layers is 0.3 g/1540.25 mm2-0.45 g/1540.25 mm2.

In some embodiments, when the battery cell is in the full-discharge state, the single-side surface density of the positive electrode active material layers is 0.35 g/1540.25 mm2-0.4 g/1540.25 mm2.

The single-side coating surface density of the positive electrode active material layers is further within the above range, which is conducive to improving the capacity of the battery. However, as the load capacity increases the thickness of the positive electrode active material layers will correspondingly increase, so that the positive electrode active material layers are excessively diffused in a process from coating to drying, and alignment deviation is generated, and consequently, the leakage of the current collector and lithium precipitation on the negative electrode side are resulted, which influence the energy density, cycle performance and safety performance of the battery cell. Therefore, in the embodiment of the present application, when the battery cell is in the full-discharge state, the single-side thickness of the main body region is 70-120 μm; the area proportion of the particles with the particle size R1 meeting 50 nm≤R1≤400 nm is 10%-35% based on the total area of the particles in the section of each positive electrode active material layer along the thickness direction of the battery cell; in the section of each positive electrode active material layer along the thickness direction of the battery cell, LA50 in the cumulative distribution curve of sphericity area of the particles is 0.6-0.8; it is particularly suitable for the battery cell with the single-side surface density of the positive electrode active material layers in the above range, which is conducive to ensuring the energy density, cycle performance and safety performance of the battery cell.

In some embodiments, when the battery cell is in the full-discharge state, the compaction density of the positive electrode plate is 2.3 g/cm3-2.6 g/cm3.

A compaction density is high so that the volume energy density of the battery is easy to improve; if the compaction density is low, a porosity of the electrode sheet is reduced and a liquid retention rate is reduced, which influences the transmission efficiency of lithium ions, thereby influencing the cycle performance and dynamics performance of the battery. In the embodiment of the present application, the compaction density of the positive electrode sheet is within the above range, which is conducive to ensuring the energy density, cycle performance and dynamics performance of the battery cell.

In some embodiments, each positive electrode active material layer further includes an insulating layer which is arranged on one side, far away from the main body region, of the thinned region.

In the embodiment of the present application, burrs on the edge of an electrode plate pierce the separator to cause lap joint of a positive electrode and a negative electrode, so that self-discharge or short circuit of the battery is caused; the insulating layer is arranged on the side, far away from the main body region, of the thinned region, which is conducive to reducing the lap joint of the positive electrode and the negative electrode caused by the burrs on the edge of the electrode plate, thereby prolonging the cycle life and improving the safety performance of the battery cell.

In some embodiments, the insulating layer includes a metal oxide.

In some embodiments, the metal oxide includes one or more of aluminum oxide, zirconium oxide, magnesium oxide and titanium oxide.

In some embodiments, the negative electrode plate includes a negative electrode current collector, and a negative electrode film layer arranged on at least one side of the negative electrode current collector; and in the thickness direction of the battery cell, a projection edge of the negative electrode film layer is on an outer side of the insulating layer.

The expansion deformation of the thick-coated electrode plate in the cycle process increases, so that the size difference between the negative electrode film layer and the positive electrode active material layer is further reduced; and in the thickness direction of the battery cell, the projection edge of the negative electrode film layer is on the outer side of the insulating layer, namely the size of the negative electrode film layer exceeds that of the positive electrode active material layer, which is conducive to provide sufficient lithium ion embedding sites on the negative electrode side, thereby reducing the risk of lithium precipitation on the negative electrode side.

In some embodiments, the size difference between the negative electrode film layer and the positive electrode active material layers in a length direction of the battery cell is 4 mm-16 mm.

The size of the negative electrode film layer and the size of the positive electrode active material layers in the length direction are within the above range, which is conducive to providing sufficient lithium ion embedding sites on the edge of the negative electrode plate in the length direction, thereby reducing the probability of lithium precipitation on the negative electrode side, and prolonging the cycle life of the battery.

In some embodiments, the size difference between the negative electrode film layer and the positive electrode active material layers in the length direction of the battery cell is 1 mm-5 mm.

The size of the negative electrode film layer and the size of the positive electrode active material layers in a width direction are within the above range, which is conducive to providing sufficient lithium ion embedding sites on the edge of the negative electrode plate in the width direction, thereby reducing the probability of lithium precipitation on the negative electrode side, and prolonging the cycle life of the battery.

In some embodiments, the positive electrode tab is arranged on at least one end, extending along the length direction of the battery cell, of the positive electrode current collector main body part.

The positive electrode tab is arranged on at least one end, extending along the length direction of the battery cell, of the positive electrode current collector main body part, namely the tab is connected to a short edge of the positive electrode current collector main body part, and this structure is beneficial to reduction of the volume of the insulating layer between the tab and the positive electrode active layers, reduction of volume occupation of a non-active material on the positive electrode plate and improvement of the load of an active substance, and therefore, the volume energy density of the battery cell is improved.

In some embodiments, the positive electrode tab is arranged on at least one end, extending along the width direction of the battery cell, of the positive electrode current collector main body part.

The positive electrode tab is arranged on at least one end, extending along the width direction of the battery cell, of the positive electrode current collector main body part, namely the tab is connected to a long edge of the positive electrode current collector main body part, which is conducive to improving the connection size of the tab and the current collector main body part; on one hand, it is conducive to processing the tab, thereby improving the production efficiency; and on the other hand, it is conducive to improving an overcurrent area of a connecting part of the current collector and the tab, thereby reducing the internal resistance, and reducing heat produced by the electrode plate.

In some embodiments, the separator includes a base film, a ceramic layer arranged on at least one side of the base film, and a binding layer arranged on the side, far away from the base film, of the ceramic layer on at least one side; the binding layer is a continuous layer of a porous structure; and the binding layer 203 includes a vinylidene fluoride polymer.

The binding layer of the separator in the related technology is generally water-based PVDF, which presents an island-shaped structure in the separator, thus it is conducive to providing a gap for expansion of the cell, and facilitates manufacturing; however, the binding layer of this separator is low in contact area with the electrode plate, and relatively weak in binding force.

According to the separator provided by the embodiment of the present application, the continuous layer of the porous structure is treated as the binding layer, and the porous structure provides a space for expansion of a thick-coated cell, so that compression of the thick-coated electrode plate on the size difference between the negative electrode film layer and the positive electrode active material layers is reduced, therefore, there are sufficient lithium intercalation sites on the negative electrode side, and the probability of lithium precipitation is reduced; in addition, the binding layer in the related technology is small in contact area with the electrode plate and small in binding force, and when the positive electrode active material layer rebounds, relative displacement between the positive electrode active material layers and the binding layer is possibly caused, thus the size difference between the negative electrode and the positive electrode is further reduced, the probability of lithium precipitation is improved, and even the positive electrode and the negative electrode are short-circuited, which influences the safety performance of the battery is; furthermore, extrusion between the separator and the electrode plate in the stacked type cell is relatively small, and the separator and the electrode plate are relatively displaced more easily, so that the separator and the electrode plate in the embodiment of the present application are bonded more firmly and uniformly, which is conducive to reducing the risk of relative displacement between the separator and the electrode plate, further reducing the probability of lithium precipitation, and improving the safety performance of the battery.

In some embodiments, the thickness of the base film in the separator is 7-9 μm.

In some embodiments, the single-side thickness of the ceramic layer in the separator is 2-4 μm.

In some embodiments, the single-side thickness of the binding layer in the separator is 1-5 μm.

The thickness of the binding layer is too small, the gap space in the separator is small, and the binding force between the separator and the electrode plate is low, so that on one hand, the size difference between the negative electrode and the positive electrode is reduced after the film layer expands, which increases the risk of lithium precipitation; and on the other hand, the probability of positive electrode in lap joint with the negative electrode is increased, which influences the safety performance of the battery. The thickness of the binding layer is too large, so the space occupancy rate of the battery is large, consequently, the volume energy density of the battery is influenced. In the embodiment of the present application, the thickness of the binding layer is within the above range, which is conducive to ensuring the cycle life, safety performance and volume energy density of the battery.

In some embodiments, a primer is arranged in a bottom region, close to the positive electrode current collector, of the positive electrode active material layer and includes a conductive agent and a binder, in which, the conductive agent includes carbon nanotubes and conductive carbon black, and the binder includes polyvinylidene fluoride (PVDF)

In some embodiments, the thickness of the primer is 0.5-5 μm.

Compared with direct contact between the positive electrode current collector and the positive electrode active material layers, the contact area between the primer and the positive electrode active material layers is increased, which is conducive to increasing an electron transmission area between the current collector and the positive electrode active material layers, thereby reducing the internal resistance of the electrode plate, and improving the dynamics performance of the battery.

In some embodiments, the positive electrode plates and the negative electrode plates are alternately stacked along the thickness direction of the battery cell; the separator forms a continuous spiral structure or a continuous “Z”-shaped structure; the separator is arranged between the adjacent positive electrode plate and negative electrode plate in a penetrating manner to separate the adjacent positive electrode plate and negative electrode plate.

The separator in the cell is in a form of a continuous plate, and it is arranged in the positive electrode plate and the negative electrode plate in a spiral structure or Z-shaped manner, and has a certain position limiting effect on the positive electrode plate and the negative electrode plate, therefore, the risk of relative displacement between the positive electrode plate and the negative electrode plate is reduced, and the safety performance and cycle performance of the battery are improved.

In some embodiments, the battery cell also includes a case in which the stacked type cell is accommodated; and the material of the case is a pouch material which includes an aluminum-plastic composite film.

In any embodiment, the material of the case includes a composite film formed by one or more of polypropylene (PP), polybutylene terephthalate (PBT), polybutylene succinate (PBS), nylon, polyethylene terephthalate (PET) and polyethylene (PE), and aluminum.

The pouch material has relatively high elongation, so the case is lighter, thinner and softer, which is conducive to increasing the space utilization rate of the battery cell, thereby improving the energy density of the battery cell. Moreover, by high barrier property of aluminum, water and oxygen penetrating into the battery can be effectively reduced, thus the decomposition of an electrolyte solution and the oxidization degree of an electrode material are reduced, thereby prolonging the service life of the battery is prolonged.

In some embodiments, the battery cell includes a case in which the stacked type cell is accommodated; and the size of the case in a length direction is L1, the size of the case in a width direction is W1, the size of the case in a thickness direction is H1, in which, 450 mm≤L1≤1300 mm, 100 mm≤W1≤150 mm, and 14 mm≤H12≤2 mm.

In some embodiments, the size of the case in the length direction is L1, 450 mm≤L1≤650 mm.

When the size L1 of the case in the length direction meets 450 mm≤L1≤650 mm, the length of the battery cell is relatively short, which is conducive to reducing a diffusion path of current, reducing the internal resistance of the electrode plate, thereby reducing the heat produced by the battery and improving the dynamics performance of the battery; and moreover, by the relatively short length of the case, the diffusion path of the electrolyte solution during the immersion process is favorably shortened, thus the immersion rate and the uniformity of the electrolyte solution are improved, the de-intercalation uniformity of lithium ions during the cycle process is further promoted, thereby improving the cycle stability of the battery cell.

In some embodiments, the size of the case in the length direction is L1, 900 mm≤L1≤1300 mm.

When the size L1 of the case in the length direction meets 900 mm≤L1≤1300 mm, the size of the battery cell is relatively long, which is conducive to reducing a volume proportion of the case in the battery cell, and increasing a load proportion of the active material. Moreover, by the relatively long battery cell, the number of batteries required in a battery module can be reduced, thus the structural design of the battery module is simplified, the number and complexity of structural members in the battery module are reduced, so that the space utilization rate of a battery pack is improved, and furthermore, the volume energy density of the battery cell is improved.

In some embodiments, the lithium-containing transition metal phosphate particles include components shown in the following general formula:

LimFexPyOjQq Formula I,
in which, Q comprises one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, O≤q≤0.1.

In a second aspect, the present application provides a battery apparatus, which includes the battery cell provided by the present application in the first aspect.

In some embodiments, the battery apparatus also includes a box body; a plurality of battery cells are stacked in rows along the thickness direction and are arranged in the box body in a binding way; reinforcement baffle is arranged between large surfaces of the cases of two adjacent battery cells and is connected to the box body, and the rigidity of the reinforcement baffle is larger than the rigidity of the case of the battery cells.

By arranging the reinforcement baffles to be connected to the box body, the reinforcement baffles can be fixed and can play an effective support effect on the battery cell, which improves the rigidity of the battery cell, thereby improving the integral rigidity of the battery apparatus.

In some embodiments, two reinforcement baffles which are arranged in an adjacent way along the thickness direction and are arranged on two sides of at least one battery cell in the thickness direction are connected by a connection plate arranged at a peripheral region of the battery cell.

By arranging the connection plate, the support reliability of the reinforcement baffles on the battery cell can be improved.

In some embodiments, the connection plate is arranged between the two connected reinforcement, the two connected reinforcement baffles are integrally connected to form a U-shaped case. Therefore, the process of connecting the connection plate and the reinforcement baffles can be omitted, and the connection reliability of the connection plate and the reinforcement baffles is further improved.

In a third aspect, the present application provides an electrical apparatus which includes the battery apparatus provided in the second aspect, and the battery apparatus is configured to provide electric energy.

In a fourth aspect, the present application provides an energy storage apparatus which includes the battery apparatus provided in the second aspect, and the battery apparatus is configured to store electric energy.

### BRIEF DESCRIPTION OF THE DRAWINGS

FIG. 1 is a schematic diagram of a positive electrode plate in an embodiment of the present application;

FIG. 2 is a schematic diagram of a separator according to an embodiment of the present application;

FIG. 3 is a schematic diagram of a separator in related technology;

FIG. 4 is a schematic diagram of a surface appearance of a binding layer according to an embodiment of the present application;

FIG. 5 is a schematic diagram of a battery apparatus according to an embodiment of the present application;

FIG. 6 is a schematic diagram of an electrical apparatus in an embodiment of the present application.

### REFERENCE NUMERALS

1, positive electrode plate; 11, positive electrode active material layer; 111, main body region; 112, thinned region; 121, positive electrode current collector main body part; 122, positive electrode tab; 13, insulating layer; X, length direction; Y, width direction; Z, thickness direction; 20, separator; 201, base film; 202, ceramic layer; 203, binding layer; 30, battery cell; 40, reinforcement baffle; and 50, connection plate.

### DETAILED DESCRIPTION

Embodiments of a battery cell, a battery apparatus, an electrical apparatus and an energy storage apparatus of the present application are specifically disclosed with appropriate reference to the attached accompanying drawings. However, there are cases where unnecessary details are omitted. For example, there are cases where detailed descriptions of well-known items and repeated descriptions of actually identical structures are omitted. This is to avoid unnecessary redundancy in the following descriptions and to facilitate understanding by those skilled in the art. In addition, the accompanying drawings and subsequent descriptions are provided for those skilled in the art to fully understand the present application, and are not intended to limit the subject matter recited in the claims.

The “ranges” disclosed in the present application are defined in the form of lower and upper limits. A given range is defined by selecting a lower limit and an upper limit, and the selected lower and upper limits define the boundaries of the particular range. The range defined in this way may include or may not include end values, and may be arbitrarily combined, that is, any lower limit can be combined with any upper limit to form a range. For example, if the ranges 60-120 and 80-110 are listed for specific parameters, it is understood that the ranges 60-110 and 80-120 are also expected. In addition, if the minimum range values 1 and 2 are listed, and if the maximum range values 3, 4 and 5 are listed, the following ranges can be all expected: 1-3, 1-4, 1-5, 2-3, 2-4 and 2-5. In the present application, unless otherwise specified, the numerical range “a-b” represents an abbreviated representation of any combination of real numbers between a and b, in which, both a and b are real numbers. For example, the numerical range “0-5” indicates that all real numbers between “0-5” have been listed in this article, and “0-5” is just an abbreviated representation of these combinations. In addition, when a parameter is expressed as an integer greater than or equal to 2, it is equivalent to disclosing that the parameter is, for example, an integer of 2, 3, 4, 5, 6, 7, 8, 9, 10, 11, 12, and the like.

Unless otherwise specifically stated, all embodiments and optional embodiments of the present application may be combined with each other to form new technical solutions, and such technical solutions should be considered as being included in the disclosure of the present application.

Unless otherwise specifically stated, all technical features and optional technical features of the present application may be combined with each other to form new technical solutions, and such technical solutions should be considered as being included in the disclosure of the present application.

Unless otherwise specified, all steps in the present application can be carried out sequentially or randomly, preferably sequentially. For example, the method includes steps (a) and (b), indicating that the method may include steps (a) and (b) in sequence, and may also include steps (b) and (a) in sequence. For example, the method may include a step (c), indicating that step (c) may be added to the method in any order, for example, the method may include steps (a), (b) and (c), may also include steps (a), (c) and (b), and may also include steps (c), (a) and (b) and the like.

In the present application, the terms “a plurality of”, and “various” refer to two or more than two.

Unless otherwise specified, the terms used in the present application have the meaning of the common knowledge as those normally understood by those skilled in the art.

Unless otherwise stated, numerical values of parameters mentioned in the present application may be measured using various testing methods commonly used in the art. For example, the numerical values may be measured according to testing methods given in the embodiments of the present application. Unless otherwise specified, the test temperature for each parameter is 25 °C.

In the embodiment of the present application, the battery apparatus can include one or more battery cell assemblies for providing voltage and capacity. The battery cell assembly can include a plurality of pouch battery cells which are connected in series, in parallel or in series-parallel connection by a bus part. For example, the battery cell assembly is generally formed by arranging a plurality of pouch battery cells; the battery cell assembly may be a battery module, and the battery module is formed by arranging and fixing a plurality of pouch battery cells to form an independent module.

As an example, the battery module may be formed by binding a plurality of battery cells with a binding tape.

The battery apparatus can be a battery pack which includes a box body and one or more battery cell assemblies, and the battery cell assembly is accommodated in the box body. The battery cell assembly may be the battery module, and the battery cell assembly can be accommodated in the box body in a manner of fixing the battery module in the box body; and the battery cell assembly can also be accommodated in the box body in a manner of directly fixing the plurality of pouch battery cells in the box body.

In the embodiment of the present application, the box body can include a first box body and a second box body. The first box body and the second box body are buckled to form an enclosure space in the box body to accommodate the battery cell assembly. Enclosure here means covering or closing, and may be sealed or unsealed. The first box body can be a top cover or a bottom plate. For example, the box body can include a top cover, a frame and a bottom plate. The top cover and the bottom plate are respectively connected to the frame, so that the enclosure space is formed in the box body to accommodate the battery cell assembly.

In the embodiment of the present application, the box body can be used as a part of a chassis structure of a vehicle. For example, part of the box body can be treated as at least a part of a floor of the vehicle, or, the part of the box body can be treated as at least a part of a cross beam and a longitudinal beam of the vehicle.

In the embodiment of the present application, the battery cell may be a secondary battery, and the secondary battery refers to the battery cell which can be continuously used by activating an active material in a charging mode after the battery cell is discharged; and the battery cell may be a lithium-ion battery. The battery cell can be flat.

The battery provided by the embodiment of the present application can be a single physical module including one or more battery cells for providing higher voltage and capacity. For example, the battery mentioned in the present application may include a battery cell, a battery module, a battery pack, or the like.

The battery cell is the smallest cell that forms the battery, and it can independently charge and discharge electricity.

When there are a plurality of battery cells, the plurality of battery cells are connected in series, in parallel or in series-parallel through a bus component. In some embodiments, the battery can be a battery module, and when a plurality of battery cells are provided, the plurality of battery cells are arranged and fixed to form a battery module. In some embodiments, the battery may be a battery pack, the battery pack includes the box body and the battery cell, and the battery cell or the battery module is accommodated in the box body. In some embodiments, the box body can be treated as a part of a chassis structure of a vehicle. For example, part of the box body can be treated as at least one part of a bottom plate of the vehicle, or, part of the box body ca be treated as at least one part of a cross beam and a longitudinal beam of the vehicle.

In some embodiments, the battery can be an energy storage apparatus. The energy storage apparatus includes an energy storage container, an energy storage electric cabinet and the like.

In some embodiments, the battery can be assembled into thee battery module, a plurality of battery cells can be in the battery module, and the specific number can be adjusted according to the application and capacity of the battery module.

In some embodiments, the battery modules can also be assembled into a battery pack, and the number of the battery modules in the battery can be selected according to the application and the capacity of the battery pack.

The battery cell includes an electrode assembly and an electrolyte.

The electrode assembly usually includes a positive electrode plate and a negative electrode plate, in which, the negative electrode plate is an electrode that occurs the reaction of absorbing or liturifying lithium ions during charging, and releasing or delithiating lithium during discharging, and the positive electrode plate is an electrode that occurs the reaction of releasing or delithiating lithium ions during charging, and absorbing or lithiating lithium during discharging.

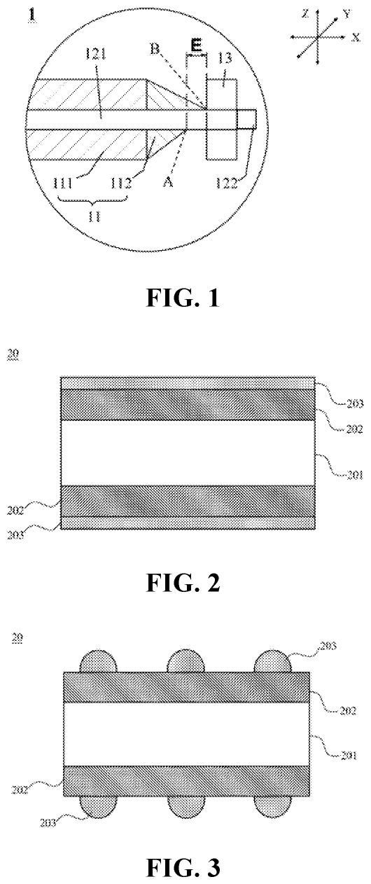

Lithium-containing transition metal phosphate has good thermal stability, cycle performance and the like, and is widely applied to a positive electrode active material of a battery. However, compared with ternary materials, the lithium-containing transition metal phosphate is relatively low in gram capacity. In related technology, the energy density of a battery cell is generally improved by the following solution: the load capacity in a unit area in a positive electrode active material layer is improved by a thick coating strategy, and meanwhile, a stacked type cell is adopted to increase the space utilization rate. However, the inventor found that this solution has new technical problem, and the thick coating strategy easily causes relatively large alignment deviation of the positive electrode active material layers on two sides of an electrode plate, as shown in FIG. 1. On one hand, a positive electrode current collector at an edge of a film layer will be exposed, consequently, an average load capacity in a unit area on the positive electrode plate is reduced, which influences the energy density of the battery cell. On the other hand, the alignment deviation will reduce the size difference between a negative electrode film layer and a positive electrode active material layer, resulting in lithium precipitation on the negative electrode side; however, the stacked type cell subjected to thick coating will generate larger volume expansion and stress in the cycle process, and the positive electrode active material layer will deform under the stress, so that the size difference between the negative electrode plate and the positive electrode plate is further reduced, the lithium precipitation phenomenon on the negative electrode side is intensified, and as a result, the safety performance and cycle stability of the battery are influenced. Therefore, how to provide a battery with high energy density, good cycle performance and safety is a technical problem which needs to be solved urgently in the field.

In order to solve above problems, the present application provides a battery cell, which includes a stacked type cell; the stacked type cell includes a positive electrode plate 1, a separator and a negative electrode plate which are sequentially stacked; the positive electrode plate 1 includes a positive electrode current collector main body part 121, a positive electrode tab 122 and positive electrode active material layers 11; the positive electrode active material layers 11 are arranged on two sides of the positive electrode current collector main body part 121 along a thickness direction Z of the battery cell; the positive electrode tab 122 is arranged on at least one side of the positive electrode current collector main body part 121; each positive electrode active material layer 11 includes a main body region 111, and a thinned region 112 arranged on the side, close to the positive electrode tab 122, of the main body region 111; a thickness of each thinned region 112 is less than that of each main body region 111; each positive electrode active material layer 11 includes a positive electrode active material; each positive electrode active material includes lithium-containing transition metal phosphate particles of which at least part of surfaces are provided with a carbon material; when the battery cell is in a full-discharge state, a single-side thickness H of each positive electrode active material layer 11 is 70-120 μm; an area proportion of particles with a particle size R1 meeting 50 nm≤R1≤400 nm is 10.0%-35.0% based on the total area of particles in a section of each positive electrode active material layer 11 along the thickness direction Z of the battery cell; and in the section of each positive electrode active material layer 11 along the thickness direction of the battery cell, LA50 in a cumulative distribution curve of sphericity area of the particles is 0.6-0.8.

According to embodiment of the present application, the battery cell relives the problems of current leakage and lithium precipitation, and meets the cycle life and safety performance while high capacity is ensured.

It is not bound by any theory, which may be because that: a stacked type cell structure can reduce an invalid space inside the battery cell, effectively eliminate inevitable corner gaps and interlayer gaps in a winding process, and make the entire cell structure more compact, thereby improving space utilization, improving the volume energy density of the battery cell, and increasing the battery capacity; in addition, the single-side thickness H of the main body is 70-120 μm, so it has a high active material load, which further improves the energy density of the battery.

In addition, film slurry of the battery is a non-Newtonian fluid which has rheological properties, including shear thinning and thixotropy. When the slurry is used for coating, a viscosity of the slurry decreases significantly when it is subjected to shear force (shear thinning), which is conducive to reducing the resistance during coating and achieving good surface flatness; after coating, the viscosity of the slurry gradually recovers (thixotropy) as the shear force is removed, resulting in a thinned region. Appropriate thixotropy helps to inhibit lateral diffusion after slurry coating, thus improving the size consistency of the thinned region at a coating boundary. In the thick-coated process, a single-side coating density of the slurry increases, and under the action of gravity, the thinned region of its edge is more likely to have uneven diffusion, resulting in alignment deviation. Therefore, it is of great significance to optimize the rheological characteristics of the slurry, which can help to enhance the film-forming consistency in the coating and drying processes and reduce the diffusion of the slurry, and further inhibit the alignment deviation caused by the deformation of a film layer.

Research shows that small particles in the slurry in the film layer had a significant impact on the rheological behavior of the slurry. The small particles are not easy to settle, which helps to improve the stability of the slurry; a colloid formed by agglomeration of the slurry helps to improve an initial viscosity, and disperses under the shear force, showing a shear thinning behavior, and after removing the shear force, it has appropriate thixotropy, and the small particles will be re-agglomerated into colloids, which helps to quickly restore the viscosity and limit the transitional diffusion of slurry. However, if there are too many small particles in the slurry, it may cause the slurry to gel, making the slurry viscosity too large, thus affecting the coating process. In addition, a roundness of the particles also significantly affects the rheological behavior of the slurry, and the colloids formed by high-sphericity particles are more easily dispersed under the shear force, which helps to enhance their shear thinning characteristics and improve the fluidity of the slurry. In the embodiment of the present application, the area proportion of the particles with the particle size R1 meeting 50 nm≤R1≤400 nm is 10%-35% based on the total area of the particles in the section of each positive electrode active material layer along the thickness direction of the battery cell; and in the section of each positive electrode active material layer along the thickness direction of the battery cell, L_{A}50 in the cumulative distribution curve of sphericity area of the particles is 0.6-0.8, which helps to achieve good shear thinning characteristics and appropriate thixotropy of the positive electrode slurry, thereby reducing the difference in the thinned region in a positive electrode film layer in a thick-coated electrode plate, reducing the alignment deviation, reducing the probability of leakage of the current collector, improving space utilization, and reducing the lithium precipitation probability on the negative electrode side, and further improving the volume energy density of the battery while ensuring the safety performance and cycle performance.

In the present application, the stacked type cell refers to a cell formed by stacking a positive electrode plate, a separator and a negative electrode plate together.

In the present application, the thickness direction of the battery cell refers to a lamination direction of the positive electrode plate, the separator and the negative electrode plate, and also the thickness direction of the positive electrode plate and the negative electrode plate.

In the present application, the lithium-containing transition metal phosphate refers to a phosphate material containing a lithium element and a transition metal element and can be detected by any known method in the field. For example, the lithium-containing transition metal phosphate materials can be detected through combination of an X-ray diffractometer (XRD), an energy spectrum analyzer and an inductively coupled plasma mass spectrometer.

In the present application, the carbon material arranged on at least one part of the surfaces of the lithium-containing transition metal phosphate particles can be detected by any known method in the field. As an example, the carbon material arranged on at least one part of the surface of the lithium-containing transition metal phosphate particles can be observed by the combination of a transmission electron microscope and an energy spectrum analyzer for representing the lithium-containing transition metal phosphate materials.

It is to be understood that the thinned region is on at least the side near the positive electrode tab. After the positive electrode active material layer is coated and dried, the positive electrode plate is subjected to polarity cutting, therefore, when the slurry is coated, an uncoated region of the tab position will be reserved on the positive electrode current collector, and the slurry will diffuse to the reserved region at the edge during the process of coating to drying, forming the thinned region with gradual thickness transition on this side, and the formation of the thinned region is closely related to the rheological behavior of the slurry. Generally, the thickness gradually decreases from the junction with the main body region to the edge near the tab, that is, the thickness of the thinned area is less than the thickness of the main body region.

In present invention, the full-discharge status refers to a status that the battery is placed in a drying oven at 25 °C and stood for 2 h, and when the temperature of the battery is maintained at 25 °C, the battery is discharged to 2.5V with constant current of ⅓ C and then discharged to be 2.0V with a constant current of 0.1 C.

A thickness of the main body region can be detected by any known mode in the field. As an example, the thickness of the main body region in the section of the positive electrode plate along the thickness direction is measured by a scanning electron microscope.

In some embodiments, the battery cell is in a full-discharge state, a single-side thickness H of the main body region is optionally 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 am, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm or a numerical range between any two of them.

In some embodiments, when the battery cell is in the full-discharge state, the single-side thickness H of the main body region is 90-120 am.

In some embodiments, when the battery cell is in the full-discharge state, the single-side thickness H of the main body region is 100-120 am.

Increasing the thickness of the positive electrode active material layer helps to increase the load of the active substance and increase the capacity of the battery. However, the applicant found that as the single-side thickness of the positive electrode active material layer increased, the alignment deviation further increased, which exacerbated the problems of leakage of the current collector and lithium precipitation, and further affected the cycle performance and safety performance of the battery cell. In the embodiment of the present application, the battery cell includes the stacked type cell, and the stacked type cell includes the positive electrode plate, the separator and the negative electrode plate which are sequentially stacked; the positive electrode plate includes the positive electrode current collector main body part, the positive electrode tab and the positive electrode active material layers; the positive electrode active material layers are arranged on two sides of the positive electrode current collector main body part along the thickness direction of the battery cell; the positive electrode tab is arranged on at least one side of the positive electrode current collector main body part; each positive electrode active material layer includes the main body region, and the thinned region arranged on the side, close to the positive electrode tab, of the main body region; the thickness of each thinned region is less than that of each main body region; each positive electrode active material layer includes the positive electrode active material; each positive electrode active material includes the lithium-containing transition metal phosphate particles of which at least part of surfaces are provided with a carbon material; when the battery cell is in the full-discharge state, the single-side thickness H of each positive electrode active material layer is 70-120 μm; the area proportion of the particles with the particle size R1 meeting 50 nm≤R1≤400 nm is 10.0%-35.0% based on the total area of particles in the section of each positive electrode active material layer along the thickness direction of the battery cell; and in the section of each positive electrode active material layer along the thickness direction of the battery cell, L_{A}50 in the cumulative distribution curve of sphericity area of the particles is 0.6-0.8, which is conducive to further improving the capacity of the battery cell, while reducing the probability of leakage of the current collector and lithium precipitation, ensuring the energy density, cycle performance and safety performance of the battery cell.

In the present application, the term “particle” refers to particles having recognizable complete boundaries in the field of view in the positive electrode active material layer at a certain magnification, such as 10,000 times, and there may be defects or scratches inside the particles, but complete boundaries that can divide the particles cannot be identified inside the particles. In the present application, the positive electrode active material layer can be a newly prepared positive electrode active material layer, or a positive electrode active material layer disassembled from the battery.

In the present application, each positive electrode active material layer includes the positive electrode active material layer, but the positive electrode active material layer does not only refer to the positive electrode active material layer, but also other film layers that are connected to the positive electrode active material layer and are difficult to distinguish, such as a base coating and a liquid retention layer, which are collectively referred to as the positive electrode active material layer.

In the present application, the particle identification method specifically includes the following steps: cutting the positive electrode active material layer along the thickness direction of the electrode plate by an argon ion beam (as an example, optionally, device model: Leica EMTIC3XCP; working voltage: 6 kV; working hours: 6 h); and after exposing the section, observing the section of the positive electrode active material layer along the thickness direction of the electrode plate by a scanning electron micrograph (as an example, optionally, device model: Hitachi SU8230; working voltage: 3 kV; the beam current: high; probe model: U (LA100); working distance: <5 mm). A field emission scanning electron micrograph is adopted to acquire images at a non-edge position in the section of the positive electrode active material layer by a secondary electron mode (after the edge of the electrode plate is observed by the scanning electron micrograph, the view is adjusted to the center of the sample), an electron micrograph is shot under 10k times of amplification ratio, and the particles in the electron micrograph are analyzed by ImageJ software (1.46r, win64 version). A use method for the ImageJ software specifically includes: loading a scanning electron micrograph to be analyzed; identifying the particles by Cellpose plug-in software, and accordingly carrying out manual correction; and reading and counting data by the ImageJ. A specific method for identifying the particles by the Cellpose plug-in software includes the following steps: setting a segmentation diameter parameter (diameter in a Segmantation module) to be 15 pixels; and after clicking “runcyto3” for particle identification, manually identifying the particles which are not identified by the software or are not completely identified by the software or have identification errors in the image. The particles which are not identified by software or are not completely identified by the software or have identification errors in the image mainly include: 1, the particles are too large or scratches are formed in the surfaces of the particles, consequently, the particles cannot be identified or cannot be completely identified; 2, scratches will be generated in the surfaces of the particles in an argon ion beam cutting process, and the software may misjudge the scratches as particle boundaries in the identification process, resulting in identification errors; 3, the particles are too small and are not successfully identified; and 4, the particles are at the edge of the visual field of the electron micrograph, the edges penetrate through the interiors of the particles, the appearance is not completely displayed, and local appearance instead of the whole appearance is identified, resulting in identification errors. The above particles which are not identified or have identification errors are manually calibrated by the following specific processes: deleting large particles which are located at the peripheral edge of the scanning electron micrograph and are not completely displayed; determining whether there are gap scratches in other particles which are not identified or have identification errors or not, if there are no gap scratches in the particles, determining the particles as one particle, and manually identifying the particles according to the manually observed particle boundaries; in response to the gap scratches in the particles, determining whether the gap scratches penetrate through the particles or not, if not, determining the particles as one particle, and manually identifying the particles; in response to the gap scratches penetrating through the particles, determining whether the gap scratches are linear or irregular; in response to that the gap scratches are irregular, determining the gap scratches as boundaries among the particles, and dividing the particles along the boundaries; in response to that the gap scratches are linear, carrying out contrast comparison; in response to that the contrast comparison is not obvious and there is no crack sense, determining the gap scratches as one particle; and in response to that the contrast comparison is strong and there is crack sense, determining the gap scratches as two particles. The above particles which are not identified or have identification errors are manually calibrated by the following specific processes: deleting large particles which are located at the peripheral edge of the scanning electron micrograph and are not completely displayed; determining whether there are gap scratches in other particles which are not identified or have identification errors or not, if there are no gap scratches in the particles, determining the particles as one particle, and manually identifying the particles according to the manually observed particle boundaries; in response to the gap scratches in the particles, determining whether the gap scratches penetrate through the particles or not, if not, determining the particles as one particle, and manually identifying the particles; in response to the gap scratches penetrating through the particles, determining whether the gap scratches are linear or irregular; in response to that the gap scratches are irregular, determining the gap scratches as boundaries among the particles, and dividing the particles along the boundaries; in response to that the gap scratches are linear, carrying out contrast comparison; in response to that the contrast comparison is not obvious and there is no crack sense, determining the gap scratches as one particle; and in response to that the contrast comparison is strong and there is crack sense, determining the gap scratches as two particles. After manual identification, information irrelevant to the particle boundaries is deleted in an automatic processing process, namely, determination and identification of the particles in the image are completed.

It is to be understood that the particles in the section of the positive electrode active material layer along the thickness direction of the electrode plate, especially the particles over 50 nm, are mainly derived from the positive electrode active material. Therefore, in the embodiment of the present application, the distribution condition of the lithium-containing transition metal phosphate particles of the positive electrode active material layer can be accurately and objectively reflected by observation and statistics on the area of the particles in the section of the positive electrode plate along the thickness direction.

In the related technology, a laser particle analyzer is usually adopted to count the particle size of the positive electrode active materials by Malvern laser diffraction. However, the applicant researched and showed that because the lithium-containing transition metal phosphate particles are prone to agglomeration, the test results obtained by the Malvern laser diffraction according to the laser scattering principle are often the particle size of particle aggregates, which cannot truly reflect the particle size of the particles in the positive electrode active material, and also cannot reflect the dispersion state of the positive electrode active material in the film layer because the dispersion degree of the positive electrode active material in the film layer will be improved in the process of pulping and film formation. The test results obtained by the Malvern laser diffraction are affected by the particle size, specific surface area, and agglomeration degree of the positive electrode active material, and compared with the real dispersion in the electrode plate, the number of large particles obtained by the test is lower than the actual value and the number of small particles is higher than the actual value, so the particle size obtained by the Malvern laser diffraction test cannot be equal to or analogous to the statistical particle size obtained in the embodiment of the present application.

A method for testing the area proportion of the particles with the particle size R1 meeting 50 nm≤R1≤400 nm in the section of the positive electrode active material layer along the thickness direction of the battery cell includes the following specific steps: identifying the particles of the positive electrode active material layer with reference to the above method in the present application, importing a picture subjected to particle determination and identification into ImageJ software for analysis, implementing scale setting according to the scanning electron micrograph, and carrying out statistical analysis on the particle size, area, sphericity and roughness of the particles in the section of the positive electrode active material layer along a direction of the battery cell through analysis functions of “Feret diameter”, “Area”, “Round” and “Solidity”. According to the software user guide (ImageJUserGuideIJ 1.46r), the parameter “Feret” obtained by analysis indicates the maximum spacing between all parallel lines in a two-dimensional projection of the particles, which represents the particle size of the particles; and the obtained parameter “Area” indicates a pixel area of the particles. The particles with the particle size less than 50 nm have a relatively great error in the statistical process, making it difficult to accurately identify, and the particle size of the conductive agent is generally less than 50 nm, which will cause relatively great error in the statistical result, and therefore, the particles with the particle size less than 50 nm are not counted in the particle size counting process in the present application, and the statistical data of the particles corresponding to AR, Round or Solidity displayed as “NaN” are deleted. A sum of the parameter “Area” of the particles with the particle size R1 meeting 50 nm≤R1≤400 nm and the sum of the parameter “Area” of all the particles are calculated and treated as the area of the particles with the particle size R1 meeting 50 nm≤R1≤400 nm and the total area of the counted particles respectively. A sum of the area of the particles with the particle size R1 meeting 50 nm≤R1≤400 nm divided by the total area of the counted particles is calculated as the total area of the particles in the section of each positive electrode active material layer along the thickness direction of the battery cell, and the area proportion of the particles with particle size R1 meeting 50 nm≤R1≤400 nm is calculated.

In some embodiments, based on the total area of the particles in the section of each positive electrode active material layer along the thickness direction of the battery cell, the area proportion of the particles with the particle size R1 meeting 50 nm≤R1≤400 nm is optionally 10%, 10.1%, 10.2%, 10.3%, 10.4%, 10.5%, 10.6%, 10.7%, 10.8%, 10.9%, 11.0%, 11.1%, 11.2%, 11.3%, 11.4%, 11.5%, 11.6%, 11.7%, 11.8%, 11.9%, 12.0%, 12.1%, 12.2%, 12.3%, 12.4%, 12.5%, 12.6%, 12.7%, 12.8%, 12.9%, 13.0%, 13.1%, 13.2%, 13.3%, 13.4%, 13.5%, 13.6%, 13.7%, 13.8%, 13.9%, 14.0%, 14.1%, 14.2%, 14.3%, 14.4%, 14.5%, 14.6%, 14.7%, 14.8%, 14.9%, 15.0%, 16%, 17%, 18%, 19%, 20%, 21%, 22%, 23%, 24%, 25%, 26%, 27%, 28%, 29%, 30%, 31%, 32%, 33%, 34%, 35% or a numerical range between any two of them.

In the present invention, a method for testing a sphericity of particles in the section of each positive electrode active material layer along the thickness direction of the battery cell includes the following specific steps: identifying the particles in the section of each positive electrode active material layer with reference to the above method in the present application f, and analyzing the morphology of the particles in the section of each positive electrode active material layer along the thickness direction of the battery cell by a “shape description” analysis function in ImageJ. According to the software user guide (ImageJ User Guide IJ 1.46r), the parameter “Round” obtained by analysis represents the ratio of the pixel area of the particles to the area of a round taking a fitted long diameter as the diameter and can be used for representing the sphericity of the particles. When the particles are closer to a round, the ratio of the pixel area to the area of the circle taking the fitted long diameter as the diameter is closer to 1. Therefore, the parameter “Round” of the particles obtained by analysis represents the sphericity of the particles. The sphericity of at least 1000 obtained particles is arranged according to an ascending sequence, taking sphericity as the horizontal axis, and taking the cumulative area proportion as the vertical axis so as to obtain the cumulative distribution curve of the sphericity of the particles in the positive electrode active material layer. The L_{A}50 is the corresponding sphericity L value at which the cumulative area proportion of the vertical axis is 50% in the cumulative distribution curve of the sphericity of the particles.

Those skilled in the art can implement regulation and control on the sphericity of the particles by any known method. As an example, the sphericity of the particles can be adjusted by processes of grinding, polishing, chemical corrosion, mechanical stirring, extruding, coating, granulating, adding a surfactant and the like, and by adjusting the parameters of each process.

In some embodiments, in the section of each positive electrode active material layer along the thickness direction of the battery cell, L_{A}50 in the cumulative distribution curve of sphericity area of the particles is optionally 0.6, 0.61, 0.62, 0.63, 0.64, 0.65, 0.66, 0.67, 0.68, 0.69, 0.70, 0.705, 0.71, 0.72, 0.73, 0.74, 0.75, 0.76, 0.77, 0.78, 0.79, 0.8 or a numerical range between any two of them.

In some embodiments, in the section of each positive electrode active material layer along the thickness direction of the battery cell, L_{A}50 in the cumulative distribution curve of sphericity area of the particles is 0.65-0.75.

In some embodiments, in the section of each positive electrode active material layer along the thickness direction of the battery cell, L_{A}50 in the cumulative distribution curve of sphericity area of the particles is 0.67-0.72.

A sphericity of the particles in the positive electrode active material layer is further within the above range, which is conducive to reducing the alignment deviation, reducing the risks of leakage of the current collector and lithium precipitation, thereby further improving the cycle performance and safety performance on the basis of improving the energy density of the battery cell.

In some embodiments, as shown in FIG. 1, projections of edges, far away from the main body region, of two thinned regions 112 on two sides of the positive electrode current collector main body part 121 in the thickness direction Z of the battery cell on the positive electrode current collector main body part are A and B respectively, and the minimum distance E from A to B is 0.1-0.6 mm.

In the present application, the projections of the edges, far away from the main body region, of the two thinned regions on two sides of the positive electrode current collector main body part in the thickness direction of the battery cell on the positive electrode current collector main body part are A and B respectively, and the minimum distance E from A to B is the alignment deviation, as shown in FIG. 1, it can be tested by a method and an instrument which are known in the field. As an example, a battery is disassembled to obtain a positive electrode plate, the positive electrode active material layers are black film layers, so the positive electrode active material layers on two sides of the positive electrode current collector can be identified by naked eyes, and the positive electrode active material layers in the thickness direction of the battery cell are projected to obtain A and B, and a high-precision micrometer (such as Mitutoyo293-100 type with the precision of 0.1 μm) can be used; or the battery is disassembled to obtain the positive electrode plate, the positive electrode plate is sliced a the direction parallel to the extension direction of the tab, a scanning electron micrograph is shot for a part, close to the tab, of the positive electrode plate, the edge of the positive electrode film layer is measured, and then the projections A and B are obtained and measured.

It is to be noted that the positive electrode plate in the present application can be freshly prepared and can also be disassembled from the battery.

In some embodiments, the projections of edges, far away from the main body region, of the two thinned regions on two sides of the positive electrode current collector main body part in the thickness direction of the battery cell on the positive electrode current collector main body part are A and B respectively, and the minimum distance E from A to B can be 0.1 mm, 0.11 mm, 0.12 mm, 0.13 mm, 0.14 mm, 0.15 mm, 0.16 mm, 0.17 mm, 0.18 mm, 0.19 mm, 0.20 mm, 0.21 mm, 0.22 mm, 0.23 mm, 0.24 mm, 0.25 mm, 0.26 mm, 0.27 mm, 0.28 mm, 0.29 mm, 0.30 mm, 0.31 mm, 0.32 mm, 0.33 mm, 0.34 mm, 0.35 mm, 0.36 mm, 0.37 mm, 0.38 mm, 0.39 mm, 0.40 mm, 0.41 mm, 0.42 mm, 0.43 mm, 0.44 mm, 0.45 mm, 0.46 mm, 0.47 mm, 0.48 mm, 0.49 mm, 0.50 mm, 0.51 mm, 0.52 mm, 0.53 mm, 0.54 mm, 0.55 mm, 0.56 mm, 0.57 mm, 0.58 mm, 0.59 mm, 0.6 mm or a numerical range between any two of them.

In the embodiments of the present application, the single-side thickness H of the main body region is 70-120 μm; the area proportion of particles with the particle size R1 meeting 50 nm≤R1≤400 nm is 10%-35% based on the total area of the particles in the section of each main body region along the thickness direction of the battery cell; and in the section of each positive electrode active material layer along the thickness direction of the battery cell, L_{A}50 in the cumulative distribution curve of sphericity area of the particles is 0.6-0.8, which is conducive to further improving consistency of the thinned region and reducing the alignment deviation into the above range, thereby improving the capacity of the battery cell, while reducing the probability of leakage of the current collector and lithium precipitation, ensuring the cycle performance and safety performance of the battery cell.

In some embodiments, the projections of the edges, far away from the main body regions, of two thinned regions on two sides of the positive electrode current collector main body part in the thickness direction of the battery cell on the positive electrode current collector main body part are A and B respectively, and the minimum distance E from A to B is 0.1-0.4 mm.

In the embodiments of the present application, the alignment deviation is further within the above range, which is conducive to further reducing the probability of leakage of the current collector and lithium precipitation, ensuring the cycle performance and safety performance of the battery cell.

In some embodiments, the area proportion of particles with the particle size R2 meeting R2≥1000 nm is 12%-30% based on the total area of the particles in the section of each positive electrode active material layer along the thickness direction of the battery cell.

In the present application, based on the total area of the particles in the section of each positive electrode active material layer along the thickness direction of the battery cell, the area proportion of the particles with the particle size R2 meeting R2≥1000 nm can be measured by the method or instrument known in the field. As an example, the test can be performed with reference to the above method for testing the area proportion of the particles with the particle size R1 meeting 50 nm≤R1≤400 nm based on the total area of the particles in the section of each positive electrode active material layer along the thickness direction of the battery cell. Specific steps: identifying the particles of the positive electrode active material layer with reference to the above method in the present application, importing a picture subjected to particle determination and identification into ImageJ software for analysis, implementing scale setting according to the scanning electron micrograph, and carrying out statistical analysis on the particle size, area, sphericity and roughness of the particles in the section of the positive electrode active material layer along the thickness direction of the electrode plate through analysis functions of “Feret”, “Area”, “Round” and “Solidity”. According to the software user guide (ImageJUserGuideIJ 1.46r), the parameter “Feret” obtained by analysis indicates the maximum spacing between all parallel lines in a two-dimensional projection of the particles, which represents the particle size of the particles; and the obtained parameter “Area” indicates a pixel area of the particles. The particles with the particle size less than 50 nm have a relatively great error in the statistical process, making it difficult to accurately identify, and the particle size of the conductive agent is generally less than 50 nm, which will cause relatively great error in the statistical result, and therefore, the particles with the particle size less than 50 nm are not counted in the particle size counting process in the present application, and the statistical data of the particles corresponding to AR, Round or Solidity displayed as “NaN” are deleted. A sum of the parameter “Area” of the particles with the particle size R2 meeting R2≥1000 nm and the sum of the parameter “Area” of all the particles are calculated and treated as the area of the particles with the particle size R2 meeting R2≥1000 nm and the total area of the counted particles respectively. A sum of the area of the particles with the particle size R2 meeting R2≥1000 nm divided by the total area of the counted particles is calculated as the total area of the particles in the section of each positive electrode active material layer along the thickness direction of the battery cell, and the area proportion of the particles with particle size R2 meeting R2≥1000 nm is calculated.

In some embodiments, based on the total area of the particles in the section of each positive electrode active material layer along the thickness direction of the battery cell, the area proportion of the particles with the particle size R2 meeting R2≥1000 nm can be 12%, 13%, 14%, 15%, 16%, 17%, 18%, 19%, 20%, 21%, 22%, 23%, 24%, 25%, 26%, 27%, 28%, 29%, 30% or a numerical range between any two of them.

The uniformity of slurry remarkably influences the shear thinning characteristic and thixotropy of the slurry. The inventor found that large particles with the particle size R2 meeting R2≥1000 nm in positive electrode slurry are easy to settle, which affects the uniformity of the slurry; in the embodiment of the present application, the area proportion of the particles with the particle size R2 meeting R2≥1000 nm is within the above range, which is conducive to improving a compaction density of the film layer and improving the capacity of a battery on one hand; and on the other hand, the particle proportion is not too high, which helps to ensure the uniformity of the slurry, makes the slurry have good shear thinning characteristic and proper thixotropy, thereby improving the capacity of the battery while reducing the alignment deviation, reducing the probability of leakage of the current collector and lithium precipitation, and ensuring good cycle performance and safety performance.

In some embodiments, in the section of each positive electrode active material layer along the thickness direction of the battery cell, a distribution uniformity of the particles with the particle size R2 meeting R2≥1000 nm is less than and equal to 5.0%.

In the present application, in the section of each positive electrode active material layer along the thickness direction of the battery cell, the distribution uniformity of the particles with the particle size R2 meeting R2≥1000 nm can be tested by the method known in the field. As an example, the section of each positive electrode active material layer along the thickness direction of the battery cell is divided into three layers with equal thickness along the thickness direction (when the surface of the positive electrode current collector is coated with the primer and then coated with each positive electrode active material layer, in the section of each positive electrode active material layer along the thickness direction of the battery cell, a region from the position, 5 μm away from the positive electrode current collector, of each positive electrode active material layer to the surface, far away from the positive electrode current collector, of each positive electrode active material layer is divided into three layers with equal thickness along the thickness direction of the electrode plate), namely a lower layer close to the positive electrode current collector, an upper layer far away from the positive electrode current collector and a middle layer between the upper layer and the lower layer; 10 non-overlapped visual fields are randomly selected from the upper layer, the middle layer and the lower layer respectively, and scanning electron micrographs are shot under 10k multiplying power; the 10 scanning electron micrographs shot from each layer are imported into ImageJ software for analysis respectively, and according to the test of “the method for testing the area proportion of the particles with the particle size R2 meeting R2≥1000 nm based on the total area of the particles in the section of each positive electrode active material layer along the thickness direction of the battery cell”, 3 numerical values, namely, the area proportion of the particles with the particle size R2 meeting R2≥1000 nm in the corresponding 10 scanning electron micrographs of the upper layer, the middle layer and the lower layer are obtained. The range of the three numerical values of the upper layer, the middle layer and the lower layer is the distribution uniformity of the particles with the particle size R2 meeting R2≥1000 nm in the section of each positive electrode active material layer along the thickness direction of the battery cell, in which, the range is the difference between the maximum value and the minimum value of the three numerical values of the upper layer, the middle layer and the lower layer. The smaller the distribution uniformity of the particles with the particle size R2 meeting R2≥1000 nm in the section of each positive electrode active material layer along the thickness direction of the battery cell is, the more uniform the distribution of the large particles with the particle size R2 meeting R2≥1000 nm in each positive electrode active material layer is.

In some embodiments, in the section of each positive electrode active material layer along the thickness direction of the battery cell, the distribution uniformity of the particles with the particle size R2 meeting R2≥1000 nm can be 0.01%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0% or a numerical range between any two of them.

In the positive electrode active material layers, the distribution uniformity of the particles with the particle size R2 meeting R2≥1000 nm is within the above range, which indicates that the particles are uniformly distributed in the positive electrode slurry, namely the uniformity of the slurry is good, the slurry has good shear thinning characteristic and proper thixotropy, therefore, the alignment deviation is reduced, the probability of leakage of the current collector and lithium precipitation is reduced, and the cycle performance and safety performance of the battery cell are further improved.

In some embodiments, in the section of each positive electrode active material layer along the thickness direction of the battery cell, the distribution uniformity of the particles with the particle size R2 meeting R2≥1000 nm is 0.2%-2.5%.

In some embodiments, in the section of each positive electrode active material layer along the thickness direction of the battery cell, the distribution uniformity of the particles with the particle size R2 meeting R2≥1000 nm is 0.2%-2%.

In the section of each positive electrode active material layer along the thickness direction of the battery cell, the distribution uniformity of the particles with the particle size R2 meeting R2≥1000 nm is 0.2%-2.5%, further, 0.2%-2%, which is conducive to further reduce the alignment deviation, reduce the probability of leakage of the current collector and lithium precipitation, thereby further improving the cycle performance and safety performance of the battery.

In some embodiments, each positive electrode active material layer further includes a binder, and the binder includes a dispersant which includes hydrogenated nitrile butadiene rubber (HNBR).

The HNBR is obtained by performing hydrogenation saturation on double bonds of nitrile butadiene rubber, and its highly saturated backbone structure ensures its excellent oil resistance, heat resistance, and aging resistance. This allows it to remain stable in different environments and systems when used as the dispersant, and is not prone to degradation or deterioration, thereby effectively exerting its dispersing effect. An HNBR molecular chain contains both polar nitrile and non-polar hydrocarbon segments. Polar nitrile groups can interact with some polar substances or particle surfaces, such as adsorbed on the surfaces of dispersed particles by hydrogen binding and electrostatic action; the non-polar hydrocarbon chain segments have good lipophilicity, which can stretch and disperse well in non-polar or weakly polar media, so that the particles are evenly dispersed in the medium. When the HNBR is adsorbed on the surfaces of the particles in the slurry, its long chain molecules will form a physical barrier around the particles, preventing the particles from approaching and aggregating with each other, so that the particles remain relatively independent in a system. Moreover, the HNBR can reduce a surface tension between the dispersed medium and the dispersed particles, making the particles more easily wetted by the medium, thereby promoting the dispersion of particles in the medium. Moreover, it can also reduce the interfacial energy between the particles, reduce the aggregation phenomenon caused by an interfacial energy drive, and improve the uniformity of the slurry. In the embodiment of the present application, the positive electrode active material layer includes the dispersant that is the hydrogenated nitrile rubber (HNBR), which helps to improve the uniformity of the slurry, thereby further reducing the alignment deviation, reducing the risk of leakage of the current collector and lithium precipitation, and ensuring good cycling performance and safety performance while improving the capacity of the battery cell.

In some embodiments, based on the total mass of the positive electrode active material layers, a mass content of the dispersant is 0.5%-2%.

In some embodiments, based on the total mass of the positive electrode active material layer, the mass content of the dispersant is optionally 0.5%, 0.6%, 0.7%, 0.8%, 0.9%, 1%, 1.5%, 2% or a numerical range between any two of them.

The mass content of the dispersant is within the above range, which is conducive to improve the uniformity of the slurry, thereby further reducing the alignment deviation, reducing the risks of leakage of the current collector and lithium precipitation, and ensuring good cycling performance and safety performance while improving the capacity of the battery cell.

In some embodiments, the positive electrode active material layer further includes a conductive agent, and based on the total area of the positive electrode active material layers in the thickness direction of the battery cell, the area proportion of an agglomeration region of the conductive agent is 0.5%-20.5%.

In the present application, the area proportion of the agglomeration region of the conductive agent based on the total area of each positive electrode active material layer along the thickness direction of the battery cell can be tested by the following method. By adopting the similar method, the section of each positive electrode active material layer along the thickness direction of the electrode plate is observed by a scanning electron microscope, and the area of the agglomeration region of the conductive agent in the scanning electron micrograph is measured under 3k times of amplification factor. The conductive agent is generally made of a carbon-based material, such as conductive carbon black, and carbon nanotubes, so that the aggregated conductive agent can be observed under the high amplification factor of the scanning electron microscope, and the agglomeration region of the conductive agent is always black and aggregated compared with other regions in each positive electrode active material layer. By means of image analysis software, the agglomeration region of the conductive agent refers to a region in which the conductive agent is obviously aggregated and is black in the scanning electron micrograph. Specifically, the scanning electron micrograph under 3k times of amplification factor is imported into ImageJ, the black agglomeration region of the conductive agent with Feret being greater than or equal to 2 μm is screened out, a sum of the area of the screened region is counted and recorded as the area of the agglomeration region of the conductive agent, and the area proportion of the agglomeration region of the conductive agent is the ratio of the area of the agglomeration region of the conductive agent to the total area of the imported scanning electron micrograph. 3 scanning electron micrograph with non-overlapped ranges are randomly taken, and an average value of the area proportion of the agglomeration region of the conductive agent is calculated to serve as “the area proportion of the agglomeration region of the conductive agent based on the total area of each positive electrode active material layer along the thickness direction of the battery cell”.

In some embodiments, each positive electrode active material layer further includes the conductive agent, and the area proportion of the agglomeration region of the conductive agent based on the total area of each positive electrode active material layer along the thickness direction of the battery cell is optionally 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5% or a numerical range between any two of them.

Based on the total area of the positive electrode active material layers along the thickness direction of the battery cell, the area proportion of the agglomeration region of the conductive agent is within the above range, which indicates that the positive electrode slurry has good uniformity, it is conducive to reducing the alignment deviation, reducing the risks of leakage of the current collector and lithium precipitation, and ensuring good cycling performance and safety performance while improving the capacity of the battery cell on one hand; and on the other hand, it indicates that the conductive agent in the positive electrode active material layer is uniformly dispersed, which is easy to form a uniform conductive network, it is particularly conducive to reducing the problem of dynamics reduction caused by increase of an ion transmission path of a thick-coated film layer, reducing the problems of local polarization and even lithium precipitation of the battery in the cycle process, thereby further prolonging the cycle life of the battery.

In some embodiments, the positive electrode active material layer further includes the conductive agent, and based on the total area of the positive electrode active material layers in the thickness direction of the battery cell, the area proportion of an agglomeration region of the conductive agent is 1.5%-20.5%.

In the embodiment of the present application, the area proportion of the agglomeration region of the conductive agent is further within the above range, which indicates that the conductive agent is more uniformly distributed in the positive electrode active material layer; and the content of the conductive agent is relatively low, which helps to reduce the occupied space of the positive electrode active material due to excessive conductive agent, thereby ensuring good cycle performance, safety performance, dynamics performance and volume energy density of the battery.

In some embodiments, the conductive agent includes carbon nanotubes which include one or more of a single-walled carbon nanotube, a few-walled carbon nanotube and a multi-walled carbon nanotube.

In the present application, the term “carbon nanotubes” refers to nanomaterials with several to tens of layers of coaxial hollow round tubes formed by rolling graphene sheets that are formed by the hybrid binding of carbon atoms by sp² hybridization. Diameters typically range from a few to several dozen nanometers, and lengths can range from m to centimeters, presenting a high-length-to-diameter ratio. According to the number of layers of graphene sheets, the carbon nanotubes can be divided into: Single-walled Carbon nanotubes (SWCNTs), Few-walled Carbon Nanotubes (FWCNTs) and Multi-walled Carbon nanotubes (MWCNTs). The carbon nanotubes have excellent electrical conductivity and high elastic modulus.

The carbon nanotubes have a one-dimensional structure, so that a network structure can be formed in the positive electrode active material layers. On one hand, the network structure is favorable for dispersing the particles in slurry, thereby improving the uniformity of the slurry, reducing the alignment deviation, reducing the risks of leakage of the current collector and lithium precipitation, further improving the capacity of the battery and ensuring good cycle performance and safety performance; and on the other hand, the network structure becomes an efficient electron transmission channel due to the excellent conductivity of the carbon nanotubes, so that the electron transmission rate of the thick-coated electrode plate in the thickness direction is increased, and the dynamics performance of the battery is improved.

In some embodiments, the conductive agent also includes the conductive carbon black.

In some embodiments, the agglomeration region of the conductive agent includes the carbon nanotubes and conductive carbon black.

Researchers found that the carbon nanotubes are prone to agglomeration due to high surface energy, resulting in uneven dispersion in the positive electrode active material layer, and inability to form an effective carbon nanotube network structure. The surface energy of the conductive carbon black is close to that of the carbon nanotubes, so the conductive carbon black can be adsorbed on the surfaces of the carbon nanotubes to form a physical barrier, which increases the agglomeration resistance of the carbon nanotubes, reduces direct contact among the carbon nanotubes, thus inhibiting the agglomeration phenomenon, and improving the distribution uniformity of the carbon nanotubes in the positive electrode active material layer. On one hand, it is conducive to improving the conductivity of the thick-coated positive electrode active material layer, and improving the dynamics performance of the battery; and on the other hand, it is conducive to playing the dispersion effect of a three-dimensional network structure of the carbon nanotubes on the particles in the positive electrode active material layers, reducing the alignment deviation, and thereby further improving the capacity, the cycle performance and the safety performance of the battery. In addition, the agglomeration of the carbon nanotubes in the agglomeration region of the conductive agent may cause blockage of the local ion transmission path of the agglomeration region of the conductive agent, and the conductive carbon black is matched to use, which can improve the lithium ion transmission capacity in this region, reduce local polarization, thereby further improving the cycle stability of the battery.

In any embodiment, based on the total mass of the positive electrode active material layer, a mass content C1 of the carbon nanotubes meets: 0<C1≤2.5%, and a mass content C2 of the conductive carbon black meets: 0<C2≤2.5%.

In some embodiments, based on the mass of the positive electrode active material layer, the mass content C1 of the carbon nanotubes is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or a numerical range between any two of them of them..

In some embodiments, based on the mass of the positive electrode active material layer, the mass content C2 of conductive carbon black is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or a numerical range between any two of them of the mass contents.

The mass content of the carbon nanotubes and the mass content of the conductive carbon black are within the above range, so that the agglomeration phenomenon of the carbon nanotubes can be effectively relieved and a good conductive network structure can be formed, thereby reducing the alignment deviation, improving the capacity of the battery and ensuring the cycle performance and the safety performance.

In some embodiments, when the battery cell is in the full-discharge state, a single-side surface density of the positive electrode active material layers is 0.25 g/1540.25 mm²-0.45 g/1540.25 mm².

In the present application, the single-side coating surface density of the positive electrode active material layers is a meaning known in the field, and can be tested by a method known in the field. For example, a positive electrode plate which is coated on one side and subjected to cold pressing (if the both sides of the positive electrode plate are coated, the positive electrode active material layer on one side can be wiped off firstly) is punched into a small wafer with the area of S₁ (a thinned area is avoided during punching, and the main body region is taken), and the weight of the small wafer is weighed and recorded as M₁. Then the positive electrode active material layers of the weighed positive electrode plate is wiped off, and the weight of the current collector is weighed and recorded as M₀. The single-side surface density of the main body region=(M₁−M₀)/S₁. In order to ensure the accuracy of the test result, a plurality of groups (such as 10 groups) of samples to be tested can be tested, and the mean value is calculated as the test result. The higher the single-side coating surface density of a positive electrode active material layer region is, the higher the load in the unit area is, so that the volume energy density of the battery cell is improved.

In some embodiments, the single-side coating surface density of each positive electrode active material layer is optionally 0.25 g/1540 mm², 0.26 g/1540 mm², 0.27 g/1540 mm², 0.28 g/1540 mm², 0.29 g/1540 mm², 0.30 g/1540 mm², 0.31 g/1540 mm², 0.32 g/1540 mm², 0.33 g/1540 mm², 0.34 g/1540 mm², 0.35 g/1540 mm², 0.36 g/1540 mm², 0.37 g/1540 mm², 0.38 g/1540 mm², 0.39 g/1540 mm², 0.40 g/1540 mm², 0.41 g/1540 mm², 0.42 g/1540 mm², 0.43 g/1540 mm², 0.44 g/1540 mm², 0.45 g/1540 mm² or a numerical range between any two of them.

In some embodiments, when the battery cell is in the full-discharge state, the single-side surface density of the positive electrode active material layers is 0.3 g/1540.25 mm²-0.45 g/1540.25 mm².

In some embodiments, when the battery cell is in the full-discharge state, the single-side surface density of the positive electrode active material layers is 0.35 g/1540.25 mm²-0.4 g/1540.25 mm².

The single-side coating surface density of the positive electrode active material layers is further within the above range, which is conducive to improving the capacity of the battery. However, as the load capacity increases the thickness of the positive electrode active material layers will correspondingly increase, so that the positive electrode active material layers are excessively diffused in a process from coating to drying, and alignment deviation is generated, and consequently, the leakage of the current collector and lithium precipitation on the negative electrode side are resulted, which influence the energy density, cycle performance and safety performance of the battery cell. Therefore, in the embodiment of the present application, when the battery cell is in the full-discharge state, the single-side thickness of the main body region is 70-120 μm; the area proportion of the particles with the particle size R1 meeting 50 nm≤R1≤400 nm is 10%-35% based on the total area of the particles in the section of each positive electrode active material layer along the thickness direction of the battery cell; in the section of each positive electrode active material layer along the thickness direction of the battery cell, L_{A}50 in the cumulative distribution curve of sphericity area of the particles is 0.6-0.8; it is particularly suitable for the battery cell with the single-side surface density of the positive electrode active material layers in the above range, which is conducive to ensuring the energy density, cycle performance and safety performance of the battery cell.

In some embodiments, when the battery cell is in the full-discharge state, the compaction density of the positive electrode plate is 2.3 g/cm³-2.6 g/cm³.

In the present application, the compaction density of the positive electrode film layer can be tested by the known mode in the field. As an example, the battery is placed in a drying oven at 25 °C and stood for 2 h; when the temperature of the battery is maintained at 25 °C, the battery is discharged to be 2.5V with constant current of ⅓ C and then discharged to be 2.0V with constant current of 0.1 C; then the battery is disassembled to obtain the positive electrode plate; the residual electrolyte solution is treated with a dimethyl carbonate solvent; the electrode plate is dried and cut into small wafers with the area of S, and the mass W1 of the electrode plate is obtained; the thickness Ti of the positive electrode plate is measured with a high precision micrometer; then the positive electrode active material layer of the weighed electrode plate is wiped off, the mass of the current collector is weighed and recorded as W₂; and the thickness T₂ of the current collector is measured with the high precision micrometer, and the compaction density of the positive electrode film layer is shown as PD=(W₁−W₂)/[(T₁−T₂)×S].

In some embodiments, when the battery cell is in the full-discharge status, the compaction density of the positive electrode active material layer is optionally 2.3 g/cm³, 2.31 g/cm³, 2.32 g/cm³, 2.33 g/cm³, 2.34 g/cm³, 2.35 g/cm³, 2.36 g/cm³, 2.37 g/cm³, 2.38 g/cm³, 2.39 g/cm³, 2.40 g/cm³, 2.41 g/cm³, 2.42 g/cm³, 2.43 g/cm³, 2.44 g/cm³, 2.45 g/cm³, 2.46 g/cm³, 2.47 g/cm³, 2.48 g/cm³, 2.49 g/cm³, 2.50 g/cm³, 2.52 g/cm³, 2.55 g/cm³, 2.6 g/cm³ or a numerical range between any two of them.

A compaction density is high so that the volume energy density of the battery is easy to improve; if the compaction density is low, a porosity of the electrode sheet is reduced and a liquid retention rate is reduced, which influences the transmission efficiency of lithium ions, thereby influencing the cycle performance and dynamics performance of the battery. In the embodiment of the present application, the compaction density of the positive electrode sheet is within the above range, which is conducive to ensuring the energy density, cycle performance and dynamics performance of the battery cell.

In some embodiments, as shown in FIG. 1, each positive electrode active material layer further includes an insulating layer 13 which is arranged on one side, far away from the main body region 111, of the thinned region 112.

In the embodiment of the present application, burrs on the edge of an electrode plate pierce the separator to cause lap joint of a positive electrode and a negative electrode, so that self-discharge or short circuit of the battery is caused; the insulating layer is arranged on the side, far away from the main body region, of the thinned region, which is conducive to reducing the lap joint of the positive electrode and the negative electrode caused by the burrs on the edge of the electrode plate, thereby prolonging the cycle life and improving the safety performance of the battery cell.

In some embodiments, the insulating layer includes a metal oxide.

In some embodiments, the metal oxide includes one or more of aluminum oxide, zirconium oxide, magnesium oxide and titanium oxide.

In some embodiments, the negative electrode plate includes a negative electrode current collector, and a negative electrode film layer arranged on at least one side of the negative electrode current collector; and in the thickness direction of the battery cell, a projection edge of the negative electrode film layer is on an outer side of the insulating layer.

In the present application, in the thickness direction of the battery cell, the projection edge of the negative electrode film layer is on the outer side of the insulating layer, namely, the projection of the edge of the negative electrode film layer in the thickness direction of the battery cell is on the outer side of the positive electrode active material layer.

The expansion deformation of the thick-coated electrode plate in the cycle process increases, so that the size difference between the negative electrode film layer and the positive electrode active material layer is further reduced; and in the thickness direction of the battery cell, the projection edge of the negative electrode film layer is on the outer side of the insulating layer, namely the size of the negative electrode film layer exceeds that of the positive electrode active material layer, which is conducive to provide sufficient lithium ion embedding sites on the negative electrode side, thereby reducing the risk of lithium precipitation on the negative electrode side.

In some embodiments, the size difference between the negative electrode film layer and the positive electrode active material layers in a length direction of the battery cell is 4 mm-16 mm.

In the present application, any two of the length direction of the battery cell, the width direction of the battery cell and the thickness direction of the battery cell are perpendicular, and the size of the battery cell in the length direction is greater than or equal to that of the battery cell in the width direction of the battery cell.

In some embodiments, the size difference between the negative electrode film layer and the positive electrode active material layer in the length direction of the battery cell is optionally 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm or a protection range between any two of the two.

The size of the negative electrode film layer and the size of the positive electrode active material layers in the length direction are within the above range, which is conducive to providing sufficient lithium ion embedding sites on the edge of the negative electrode plate in the length direction, thereby reducing the probability of lithium precipitation on the negative electrode side, and prolonging the cycle life of the battery.

In some embodiments, the size difference between the negative electrode film layer and the positive electrode active material layers in the length direction of the battery cell is 1 mm-5 mm.

In some embodiments, the size difference between the negative electrode film layer and the positive electrode active material layer in the width direction of the battery cell can be 1 mm, 1.2 mm, 1.4 mm, 1.6 mm, 1.8 mm, 2 mm, 2.2 mm, 2.4 mm, 2.6 mm, 2.8 mm, 3 mm, 3.2 mm, 3.4 mm, 3.6 mm, 3.8 mm, 4 mm, 4.2 mm, 4.4 mm, 4.6 mm, 4.8 mm, 5 mm or a numerical range between any two of them.

The size of the negative electrode film layer and the size of the positive electrode active material layers in a width direction are within the above range, which is conducive to providing sufficient lithium ion embedding sites on the edge of the negative electrode plate in the width direction, thereby reducing the probability of lithium precipitation on the negative electrode side, and prolonging the cycle life of the battery.

In some embodiments, the positive electrode tab is arranged on at least one end, extending along the length direction of the battery cell, of the positive electrode current collector main body part.

The positive electrode tab is arranged on at least one end, extending along the length direction of the battery cell, of the positive electrode current collector main body part, namely the tab is connected to a short edge of the positive electrode current collector main body part, and this structure is beneficial to reduction of the volume of the insulating layer between the tab and the positive electrode active layers, reduction of volume occupation of a non-active material on the positive electrode plate and improvement of the load of an active substance, and therefore, the volume energy density of the battery cell is improved. In some embodiments, the positive electrode tab is arranged on at least one end, extending along the width direction of the battery cell, of the positive electrode current collector main body part.

The positive electrode tab is arranged on at least one end, extending along the width direction of the battery cell, of the positive electrode current collector main body part, namely the tab is connected to a long edge of the positive electrode current collector main body part, which is conducive to improving the connection size of the tab and the current collector main body part; on one hand, it is conducive to processing the tab, thereby improving the production efficiency; and on the other hand, it is conducive to improving an overcurrent area of a connecting part of the current collector and the tab, thereby reducing the internal resistance, and reducing heat produced by the electrode plate.

In some embodiments, as shown in FIG. 2, the separator 20 includes a base film 201, a ceramic layer 202 arranged on at least one side of the base film 201, and a binding layer 203 arranged on the side, far away from the base film 201, of the ceramic layer 202 on at least one side; the binding layer 203 is a continuous layer of a porous structure; and the binding layer 203 includes a vinylidene fluoride polymer.

In some embodiments, the separator includes the base film, the ceramic layers arranged on the two sides of the base film, and the binding layers arranged on the two sides, far away from the base film, of the ceramic layers.

In some embodiments, the vinylidene fluoride polymer includes one or more of polyvinylidene fluoride (PVDF) and polyvinylidene fluoride-hexafluoropropylene (PVDF-HFP).

In some embodiments, the vinylidene fluoride type polymer includes the polyvinylidene fluoride (PVDF).

In related technology, the binding layer of the separator is usually made of water-based PVDF, and it is of an island-shaped structure in the separator, as shown in FIG. 3, on one hand, it is beneficial for providing a gap for the battery cell to expand, and on the other hand, convenience is provided for manufacturing; however, a contact area between the binding layer of the separator and the electrode plate is small, so the binding force is weak.

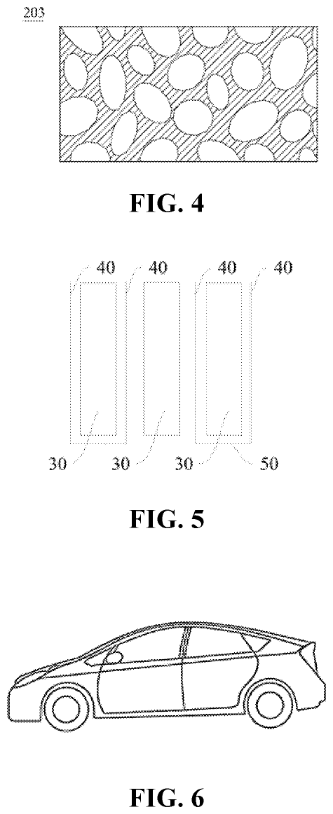

According to the separator provided by the embodiment of the present application, as shown in FIG. 2 and FIG. 4, the continuous layer of the porous structure is treated as the binding layer, and the porous structure provides a space for expansion of a thick-coated cell, so that compression of the thick-coated electrode plate on the size difference between the negative electrode film layer and the positive electrode active material layers is reduced, therefore, there are sufficient lithium intercalation sites on the negative electrode side, and the probability of lithium precipitation is reduced; in addition, the binding layer in the related technology is small in contact area with the electrode plate and small in binding force, and when the positive electrode active material layer rebounds, relative displacement between the positive electrode active material layers and the binding layer is possibly caused, thus the size difference between the negative electrode and the positive electrode is further reduced, the probability of lithium precipitation is improved, and even the positive electrode and the negative electrode are short-circuited, which influences the safety performance of the battery is; furthermore, extrusion between the separator and the electrode plate in the stacked type cell is relatively small, and the separator and the electrode plate are relatively displaced more easily, so that the separator and the electrode plate in the embodiment of the present application are bonded more firmly and uniformly, which is conducive to reducing the risk of relative displacement between the separator and the electrode plate, further reducing the probability of lithium precipitation, and improving the safety performance of the battery.

It is to be understood that the continuous binding layer may be broken and deformed into a block structure due to contact with the positive electrode plate or the negative electrode plate or extrusion stress in the manufacturing or circulating process of the electrode plates, and the continuous structure in the present application refers to that the binding layer of the separator is continuous at a microscopic level, such as observation under the scanning electron microscope or an optical microscope. In order to feed back the real morphology of the separator, sampling is preferably carried out in a region, which is not bound with the positive electrode plate or the negative electrode plate, of the binding layer of the separator in the battery in the sampling process. As an example, sampling is carried out at a separator position exceeding the positive electrode plate and the negative electrode plate; or sampling is carried out on the separator close to the surface of the electrode assembly. The binding between a separator sampling region and the positive electrode plate or the negative electrode plate is small, so that the real state of the separator can be better fed back.

In some embodiments, the material of the base film can include but is not limited to one or more of glass fiber, non-woven fabric, Polyethylene (PE) and Polpropylene (PP).

In some embodiments, each ceramic layer includes one or more of aluminum oxide (Al₂O₃), zirconium oxide (ZrO₂), titanium oxide (TiO₂), silicon oxide (SiO₂) and boron nitride (BN).

The ceramic particles have flame retardancy and a relatively high hardness value, and are not easy to deform when heated, so the ceramic particles are excellent in dimensional stability. The thermal conductivity of the ceramic material is low, so that the condition that some thermal runaway points in the battery are expanded to cause overall thermal runaway can be further prevented, and thus the safety performance of the battery cell is improved.

In some embodiments, the thickness of the base film in the separator is 7-9 μm.

In some embodiments, the thickness of the base film in the separator is optionally 7 μm, 7.5 μm, 8 μm, 8.5 μm, 9 μm or a numerical range between any two of them.

In some embodiments, the single-side thickness of the ceramic layer in the separator is 2-4 μm.

In some embodiments, the single-side thickness of the ceramic layers in the separator is optionally 2 μm, 2.5 μm, 3 μm, 3.5 μm, 4 μm or a numerical range between any two of them.

In some embodiments, the single-side thickness of the binding layer in the separator is 1-5 μm.

In some embodiments, the single-side thickness of the binding layers in the separator is optionally 1 am, 1.5 μm, 2 μm, 2.5 μm, 3 μm, 3.5 μm, 4 μm, 4.5 μm, 5 μm or a numerical range between any two of them.

In the present application, the “thickness” is a meaning known in the field, and can be measured by a method and an instrument known in the field. As an example, a high-precision micrometer (such as Mitutoyo293-100 type with the precision of 0.1 μm) can be used for testing.

The thickness of the binding layer is too small, the gap space in the separator is small, and the binding force between the separator and the electrode plate is low, so that on one hand, the size difference between the negative electrode and the positive electrode is reduced after the film layer expands, which increases the risk of lithium precipitation; and on the other hand, the probability of positive electrode in lap joint with the negative electrode is increased, which influences the safety performance of the battery. The thickness of the binding layer is too large, so the space occupancy rate of the battery is large, consequently, the volume energy density of the battery is influenced. In the embodiment of the present application, the thickness of the binding layer is within the above range, which is conducive to ensuring the cycle life, safety performance and volume energy density of the battery.

In some embodiments, a primer is arranged in a bottom region, close to the positive electrode current collector, of the positive electrode active material layer and includes a conductive agent and a binder, in which, the conductive agent includes carbon nanotubes and conductive carbon black, and the binder includes polyvinylidene fluoride (PVDF)

In some embodiments, the thickness of the primer is 0.5-5 μm.

In some embodiments, the thickness of the primer is optionally 0.5 μm, 1 μm, 1.5 μm, 2 μm, 2.5 μm, 3 μm, 3.5 μm, 4 μm, 4.5 μm, 5 μm or a numerical range between any two of them.

Compared with direct contact between the positive electrode current collector and the positive electrode active material layers, the contact area between the primer and the positive electrode active material layers is increased, which is conducive to increasing an electron transmission area between the current collector and the positive electrode active material layers, thereby reducing the internal resistance of the electrode plate, and improving the dynamics performance of the battery.

In some embodiments, the positive electrode plates and the negative electrode plates are alternately stacked along the thickness direction of the battery cell; the separator forms a continuous spiral structure or a continuous “Z”-shaped structure; the separator is arranged between the adjacent positive electrode plate and negative electrode plate in a penetrating manner to separate the adjacent positive electrode plate and negative electrode plate.

The separator in the cell is in a form of a continuous plate, and it is arranged in the positive electrode plate and the negative electrode plate in a spiral structure or Z-shaped manner, and has a certain position limiting effect on the positive electrode plate and the negative electrode plate, therefore, the risk of relative displacement between the positive electrode plate and the negative electrode plate is reduced, and the safety performance and cycle performance of the battery are improved.

In some embodiments, the battery cell also includes a case in which the stacked type cell is accommodated; and the material of the case is a pouch material which includes an aluminum-plastic composite film.

In any embodiment, the material of the case includes a composite film formed by one or more of polypropylene (PP), polybutylene terephthalate (PBT), polybutylene succinate (PBS), nylon, polyethylene terephthalate (PET) and polyethylene (PE), and aluminum.

The pouch material has relatively high elongation, so the case is lighter, thinner and softer, which is conducive to increasing the space utilization rate of the battery cell, thereby improving the energy density of the battery cell. Moreover, by high barrier property of aluminum, water and oxygen penetrating into the battery can be effectively reduced, thus the decomposition of an electrolyte solution and the oxidization degree of an electrode material are reduced, thereby prolonging the service life of the battery is prolonged.

In some embodiments, the battery cell includes a case in which the stacked type cell is accommodated; and the size of the case in a length direction is L₁, the size of the case in a width direction is W₁, the size of the case in a thickness direction is H₁, in which, 450 mm≤L₁≤1300 mm, 100 mm≤W₁≤150 mm, and 14 mm≤H₁≤22 mm.

In some embodiments, L₁ is optionally, 450 mm, 480 mm, 490 mm, 500 mm, 510 mm, 520 mm, 530 mm, 540 mm, 550 mm, 560 mm, 570 mm, 580 mm, 590 mm, 600 mm, 610 mm, 620 mm, 630 mm, 640 mm, 650 mm, 660 mm, 670 mm, 680 mm, 690 mm, 700 mm, 710 mm, 720 mm, 750 mm, 800 mm, 850 mm, 900 mm, 950 mm, 1,000 mm, 1,050 mm, 1,100 mm, 1,150 mm, 1,200 mm, 1,250 mm, 1,300 mm or a numerical range between any two of them.

In some embodiments, W1 is optionally 100 mm, 110 mm, 120 mm, 130 mm, 140 mm, 150 mm or a numerical range between any two of them.

In some embodiments, H₁ is optionally 14 mm, 15 mm, 16 mm, 17 mm, 18 mm, 19 mm, 20 mm, 21 mm, 22 mm or a numerical range between any two of them.

In some embodiments, the size of the case in the length direction is L1, 450 mm≤L₁≤650 mm.

When the size L₁ of the case in the length direction meets 450 mm≤L₁≤650 mm, the length of the battery cell is relatively short, which is conducive to reducing a diffusion path of current, reducing the internal resistance of the electrode plate, thereby reducing the heat produced by the battery and improving the dynamics performance of the battery; and moreover, by the relatively short length of the case, the diffusion path of the electrolyte solution during the immersion process is favorably shortened, thus the immersion rate and the uniformity of the electrolyte solution are improved, the de-intercalation uniformity of lithium ions during the cycle process is further promoted, thereby improving the cycle stability of the battery cell.

In some embodiments, the size of the case in the length direction is L1, 900 mm≤L₁≤1300 mm.

When the size L₁ of the case in the length direction meets 900 mm≤L₁≤1300 mm, the size of the battery cell is relatively long, which is conducive to reducing a volume proportion of the case in the battery cell, and increasing a load proportion of the active material. Moreover, by the relatively long battery cell, the number of batteries required in a battery module can be reduced, thus the structural design of the battery module is simplified, the number and complexity of structural members in the battery module are reduced, so that the space utilization rate of a battery pack is improved, and furthermore, the volume energy density of the battery cell is improved.

In some embodiments, the lithium-containing transition metal phosphate particles include components shown in the following general formula:

LiₘFeₓP_{y}OⱼQ_{q} Formula I,
in which, Q comprises one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, 0≤q≤0.1.

In some embodiments, m is optionally 0.8, 0.85, 0.9, 0.95, 0.98, 1.00, 1.03, 1.05, 1.08, 1.10, 1.13, 1.15 or a numerical range between any two of them of them; x is optionally 0.9, 0.91, 0.92, 0.93, 0.94, 0.95, 0.96, 0.97, 0.98, 0.99, 1.0 or a numerical range between any two of them of them; y is optionally 0.95, 0.96, 0.97, 0.98, 0.99, 1.00 or a numerical range between any two of them of them; j is optionally 3.5, 3.6, 3.7, 3.8, 3.9, 4 or a numerical range between any two of them of them; and q is optionally 0, 0.01, 0.02, 0.03, 0.04, 0.05, 0.06, 0.07, 0.08, 0.09, 0.1 or a numerical range between any two of them of them.

In some embodiments, the lithium-containing transition metal phosphate particles in the positive electrode active material layer include one or more of lithium iron phosphate, lithium manganese phosphate, lithium vanadium fluorophosphate, lithium manganese iron phosphate and modified materials thereof.

In some embodiments, the lithium-containing transition metal phosphate particles in the positive electrode active material layer include one or more of lithium iron phosphate and doped modified materials thereof, and coated modified materials thereof.

In a second aspect, the present application provides a battery apparatus, which includes the battery cell provided by the present application in the first aspect.

In some embodiments, the battery apparatus also includes a box body; as shown in FIG. 5, a plurality of battery cells 30 are stacked in rows along the thickness direction and are arranged in the box body in a binding way; reinforcement baffle 40 is arranged between large surfaces of the cases of two adjacent battery cells 30 and is connected to the box body, and the rigidity of the reinforcement baffle 40 is larger than the rigidity of the case of the battery cells 30.

By arranging the reinforcement baffles to be connected to the box body, the reinforcement baffles can be fixed and can play an effective support effect on the battery cell, which improves the rigidity of the battery cell, thereby improving the integral rigidity of the battery apparatus.

In some embodiments, as shown in FIG. 5, two reinforcement baffles 40 which are arranged in an adjacent way along the thickness direction and are arranged on two sides of at least one battery cell 30 in the thickness direction are connected by a connection plate 50 arranged at a peripheral region of the battery cell.

By arranging the connection plate, the support reliability of the reinforcement baffles on the battery cell can be improved.

In some embodiments, the connection plate is arranged between the two connected reinforcement, the two connected reinforcement baffles are integrally connected to form a U-shaped case. Therefore, the process of connecting the connection plate and the reinforcement baffles can be omitted, and the connection reliability of the connection plate and the reinforcement baffles is further improved.

The electrical apparatus disclosed by the embodiment of the present application can be used in an electrical apparatus using the battery apparatus as a power source or various energy storage systems using the battery apparatus as an energy storage element. The electrical apparatus can be used in vehicles, or other but not limited to mobile phones, tablet computers, notebook computers, electric toys, electric tools, electric vehicles, electric automobiles, ships, spacecraft and the like. The electric toys can include a fixed or mobile electric toy, such as a game machine, an electric automobile toy, an electric ship toy and an electric aircraft toy, and the spacecraft can include an aircraft, a rocket, a space shuttle, a spacecraft and the like.

In a third aspect, the present application further provides an electrical apparatus using the battery apparatus as a power source, which includes at least one of the battery cell, the battery module, or the battery pack provided by the present application. The battery cell, the battery module or the battery pack can be used as the power source for the electric device and can also be used as an energy storage unit for the electrical apparatus. For the electrical apparatus, the battery cell, the battery module or the battery can be selected according to the use requirements.

FIG. 6 shows an electrical apparatus taken as an example. The electrical apparatus disclosed by the embodiment of the present application may be a fuel vehicle, a gas vehicle or a new energy vehicle, and the new energy vehicle may be a pure electric vehicle, a hybrid electric vehicle or an extended-range vehicle and the like. A battery apparatus is arranged in the vehicle, and the battery apparatus can be arranged at the bottom or head or tail of the vehicle. The battery apparatus may be used for supplying power to the vehicle, for example, the battery apparatus may serve as an operation power source of the vehicle. The vehicle can further include a controller and a motor, and the controller is configured to control the battery apparatus to supply power to the motor, for example, the controller is configured to meet the working power consumption requirements of the vehicle in starting, navigation and driving. In some embodiments of the present application, the battery apparatus can be used as an operation power supply of the vehicle, can also be used as a driving power supply of the vehicle, and replaces or partially replaces fuel oil or natural gas to provide driving power for the vehicle.

In a fourth aspect, the present application also provides an energy storage apparatus using the battery apparatus as a power source; and the energy storage apparatus can be, but not limited to, an energy storage container, an energy storage cabinet, an energy storage power station, an energy storage battery pack or a portable energy storage system and the like.

### EXAMPLES

Examples of the present application will be described below. The Examples described below are illustrative and only used to explain the present application, and cannot be construed as limiting the present application. In Examples in which no specific technologies or conditions are specified, technologies or conditions described in the literature in the art or product specifications are followed. Where manufacturers are not specified, the reagents or instruments used are conventional products and are commercially available.

Examples of the present application will be described hereinafter. The Examples described below are illustrative and only used to explain the present application, and cannot be construed as limiting the present application. In Examples in which no specific technologies or conditions are specified, technologies or conditions described in the literature in the art or product specifications are followed. The reagents or instruments used without manufacturer indicated are all commercially available conventional products.

### Example 1

### (1) Preparation of Positive Electrode Active Material

Lithium carbonate, iron phosphate, titanium dioxide, vanadium pentoxide, sucrose, glucose and polyethylene glycol were added to de-ionized water and mixed in a pre-mixing tank, in which, the molar ratio of lithium to iron was 1.02:1.0 based on the ratio of the lithium carbonate to the iron phosphate; based on the total mass of mixed raw materials, the mass content of the sucrose was 2%, the mass content of the glucose was 4%, and the mass content of the polyethylene glycol was 5%; after uniformly mixing, the mixed raw materials with the solid content of 45% was obtained;

A mixed raw material was divided into two parts according to a ratio of 1:1, and then was subjected to ball milling and demagnetizing by a ball mill respectively so as to obtain a first abrasive and a second abrasive; the first abrasive was ground by a sand mill for 12 h at a frequency of 24 Hz; the temperature of slurry was controlled to be lower than 40 °C in the grinding process to obtain first grinding slurry, and a particle size Dv50 of solid particles in the first grinding slurry was 0.5 μm; the second abrasive was ground by the sand mill for 8 h at a frequency of 22 Hz; the temperature of the slurry was controlled to be lower than 40 °C in the grinding process to obtain second grinding slurry, and the particle size Dv50 of the solid particles in the second grinding slurry was 1.8 μm; the first grinding slurry and the second grinding slurry were mixed according to a mass ratio of 85:15, and then was subjected to spray drying to obtain mixed precursor powder;

the mixed slurry was subjected to spray drying to obtain precursor powder, and the precursor powder was sintered to obtain a lithium iron phosphate positive electrode material; the sintering process included: performing two-stage temperature-rise sintering on the precursor powder in a nitrogen atmosphere to obtain a positive electrode active material; increasing the temperature to 500 °C from 25 °C at a temperature rise rate of 3 °C/min (a first temperature-rise stage), and maintaining the temperature for 3 h; increasing the temperature to 780 °C from 500 °C at the temperature rise rate of 5 °C/min (a second temperature-rise stage), and maintaining the temperature for 10 h, in which, the ventilation capacity in the temperature-rise stages was larger than that in a constant temperature stage, the proportion was 1.3:1, the total ventilation capacity was 1,500 cm³/h; and finally, decreasing the temperature to cool to be less than 100 °C;

the sintered product was smashed by an airflow smashing method, the Dv90 was controlled to be 5-10 μm, and thus the lithium iron phosphate positive electrode active material with the surface provided with a carbon material was obtained. Based on the total mass of the positive electrode active material, the mass content of Ti element was 1,000 ppm, and the mass content of V element was 900 ppm;

The Dv10, Dv50 and Dv90 referred to the corresponding particle size values when the cumulative distribution percentage of a particle volume obtained by the Malvern laser scattering method reached 10%, 50% and 90%, respectively.

### (2) Preparation of Positive Electrode Plate

95% by mass of the positive electrode active material, 1.5% by mass of the conductive agent, 2.5% by mass of the binder that was polyvinylidene fluoride, and 1% by mass of a dispersant that was HNBR were mixed in a solvent that was N-methyl pyrrolidone, then fully mixed in a stirring tank, stirred, and dispersed to obtain positive electrode slurry; after the stirring process, the positive electrode slurry was conveyed to a coating process; the mass proportion of the positive electrode active material, the conductive agent, the binder and the dispersant was calculated based on the total mass of solids in the positive electrode slurry; the conductive agent included 1% by mass of conductive carbon black and 0.5% by mass of carbon nanotubes; the specific surface area of the conductive carbon black was 85 m²/g, and the oil absorption value was 200 ml/100 g; an average length of the carbon nanotubes was 25 μm, and the specific surface area was 300 m²/g; the mass content of metal impurities in the carbon nanotubes was less than 1 wt %;

a positive electrode current collector was selected to be prepared from an aluminum foil, and a thickness of the aluminum foil was 8 μm; the positive electrode slurry was coated on the aluminum foil by extrusion and then was roasted, and rolling was carried out to obtain a positive electrode plate with a single-side thickness of a positive electrode film layer being 105.76 μm and a compaction density being 2.34 g/cm³. A rolling process included a primary cold rolling process and a primary hot rolling process, the cold rolling pressure at room temperature was 45 tons, the hot rolling pressure at 70 °C was 75 tons, and a thickness range of the positive electrode film layer after the hot rolling process was 0.5 μm.

An insulating layer was configured between the positive electrode active material layers and a positive electrode tab, and an alignment deviation E of the positive electrode film layers on two sides in the thickness direction of the battery cell was 0.3 mm.

### (3) Preparation of Negative Electrode Plate

Large-particle artificial graphite with relatively concentrated particle size distribution was selected, specifically, the particle size Dv10 of artificial graphite powder was 9 μm, the particle size Dv50 of the artificial graphite powder was 20 μm, the particle size Dv90 of the artificial graphite powder was 40 μm, and the graphitization degree of the artificial graphite was 93%; the Dv10, Dv50 and Dv90 referred to the corresponding particle size values when the cumulative distribution percentage of a particle volume obtained by the Malvern laser scattering method reached 10%, 50% and 90%, respectively;

Artificial graphite, a conductive agent that was conductive carbon black, a binder that was Styrene Butadiene Rubber (SBR) and a thickener that was sodium carboxymethyl cellulose (CMC) were uniformly mixed according to the weight percentage of 95:1.0:2.0:2.0, then deionized water was added, and all materials were stirred and dispersed to obtain negative pole slurry; and a substrate copper foil was coated with the negative pole slurry, and then subjected to drying, cold pressing, slitting and tabletting to obtain the negative electrode plate.

The length of the positive electrode active material layers was 544.5 mm, the width of the positive electrode active material layers was 118.2 mm, and the length of a negative electrode film layer was 550 mm, and the width of the negative electrode film layer was 119.5 mm.

### (4) Separator

Polyvinylidene fluoride (PVDF) was dissolved in N-methyl pyrrolidone (NMP), and uniformly stirred; polyethylene glycol (PEG) was added as a pore-forming agent, and fully stirred and mixed to obtain a binding layer solution. A base film with ceramic layers on both sides was coated with the binding layer solution; after pre-volatilizing at 80 °C and drying at 110 °C, the base film was immersed in deionized water to dissolve out PEG so as to obtain a separator with the binding layers of porous structures on both sides. The thickness of the base film was 8 μm, the thickness of the ceramic layer on one side was 3 μm, and the thickness of the binding layer on one side was 1 μm.

### (5) Electrolyte Solution

In an argon atmosphere glove box (H₂O<0.1 ppm, O₂<0.1 ppm), organic solvents that were dimethyl carbonate (DMC), Ethyl Methyl Carbonate (EMC) and Ethylene Carbonate (EC) were uniformly mixed according to the mass ratio of 30:50:20.

Lithium hexafluorophosphate was added and dissolved in an organic solvent, so that the concentration of an electrolyte solution was 1.05 mol/L, and the electrolyte solution was uniformly stirred to obtain the electrolyte solution in the Example 1.

### (6) Preparation of Battery:

The positive electrode plate and the negative electrode plate were slit and punched into a specified shape, and the punched positive electrode plate was graded according to weight by a sorting and weighing machine. The positive electrode plate and the negative electrode plate were conveyed to a compositing station, and were alternately thermally composited on a surface of a single side of the separator to form a three-in-one composite belt; the composite belt was continuously wound to a preset number of layers, then the winding was stopped, the composite belt was cut off, thus the separator formed a spiral structure arranged between the positive electrode plate and the negative electrode plate which are adjacent to each other so as to obtain a stacked type cell. The stacked type cell was glued until being tightly wrapped. The glued stacked type cell was placed in an outer package, and the outer package was a pouch material aluminum-plastic film which was formed by compositing inner-layer polypropylene, middle-layer aluminum foil and outer-layer nylon. An aluminum-plastic film outer package was subjected to double-surface punching and trimming by a punching molding machine to obtain a target shape and a target size. Then the aluminum-plastic film was thermally packaged to meet the requirement that the packaging tension of the aluminum-plastic film was more than or equal to 25 N/8 mm.

The battery was roasted in vacuum, stood, injected with an electrolyte solution, and packaged; and then the pouch battery was subjected to hot pressing and cold pressing operation, the hot pressing was performed for 2 min at 45 °C under pressure of 90 kg/cm², the cold pressing was performed for 2 min at 25 °C under pressure of 90 kg/cm². Finally, the processes of formation, vacuumizing, exhausting, trimming and the like were carried out to obtain the battery cell. The size of the battery cell in the length direction was 600 mm, the size of the battery cell in the width direction was 125 mm, and the size H1 of the battery cell in the thickness direction was 20 mm.

### Example 2

A preparation method in the Example 2 was basically consistent with that in the Example 1, and the difference was in the preparation process of the positive electrode active material, the preparation process of the positive electrode plate and the size of the film layer in the electrode plate, specifically,
the difference in the preparation process of the positive electrode active material was as follows:
   (2) mixing the first abrasive and the second abrasive according to the mass ratio of 60:40 to obtain a mixed intermediate product; and performing spray drying on the mixed intermediate product; and
   (3) powder was sintered to obtain a lithium iron phosphate positive electrode material, and the sintering process included:

first sintering: the precursor powder was sintered in a nitrogen atmosphere, subjected to temperature rise from 25 °C to 765 °C at a temperature rise rate of 2 °C/min, maintained at the temperature for 8 h, and then cooled to obtain a first sintered product;
second sintering: the dried mixed intermediate product was sintered in a nitrogen atmosphere, subjected to temperature rise from 25 °C to 800 °C at a temperature rise rate of 2 °C/min, maintained at the temperature for 10 h, and then cooled to obtain a second sintered product.

The difference in the preparation process of the positive electrode plate was as follows: adjusting the pressure, calendering speed, rolling time and rolling temperature in a rolling process to control the slurry coating thickness so as to obtain the positive electrode plate with the single-side thickness of the positive electrode film layer being 105.89 μm and the compaction density being 2.34 g/cm³.

The size of the film layer in the electrode plate was as follows: the length of the positive electrode active material layer was 544.3 mm, the width of the positive electrode active material layer was 118.7 mm, and the length of the negative electrode film layer was 550.8 mm, and the width of the negative electrode film layer was 120.3 mm.

### Example 3

A preparation method in the Example 3 was basically consistent with that in the Example 1, and the difference was in the preparation process of the positive electrode active material, the preparation process of the positive electrode plate and the size of the film layer in the electrode plate, specifically,
the difference in the preparation process of the positive electrode active material was as follows:
   (4) mixing the first abrasive and the second abrasive according to the mass ratio of 30:70 to obtain a mixed intermediate product; and performing spray drying on the mixed intermediate product; and
   (5) powder was sintered to obtain a lithium iron phosphate positive electrode material, and the sintering process included:

first sintering: the precursor powder was sintered in a nitrogen atmosphere, subjected to temperature rise from 25 °C to 765 °C at a temperature rise rate of 2 °C/min, maintained at the temperature for 8 h, and then cooled to obtain a first sintered product;

second sintering: the dried mixed intermediate product was sintered in a nitrogen atmosphere, subjected to temperature rise from 25 °C to 850 °C at a temperature rise rate of 5 °C/min, maintained at the temperature for 12 h, and then cooled to obtain a second sintered product.

The difference in the preparation process of the positive electrode plate was as follows:

adjusting the pressure, calendering speed, rolling time and rolling temperature in a rolling process to control the slurry coating thickness so as to obtain the positive electrode plate with the single-side thickness of the positive electrode film layer being 106.42 μm and the compaction density being 2.36 g/cm³.

The size of the film layer in the electrode plate was as follows: the length of the positive electrode active material layer was 544.3 mm, the width of the positive electrode active material layer was 118.7 mm, and the length of the negative electrode film layer was 550.8 mm, and the width of the negative electrode film layer was 120.3 mm.

### Example 4

A preparation method in the Example 4 was basically the same as that in the Example 1, and the difference was in the preparation process of the positive electrode plate and the size of the film layer in the electrode plate, specifically,
the grinding time was changed to obtain second grinding slurry, and the particle size Dv50 of solid particles in the second grinding slurry was 2.5 μm;
the difference in the preparation process of the positive electrode plate was as follows:
adjusting the preparation method for the positive electrode plate, specifically adjusting the pressure, calendering speed, rolling time and rolling temperature in a rolling process to control the slurry coating thickness so as to obtain the positive electrode plate with the single-side thickness of the positive electrode film layer being 126.51 μm and the compaction density being 2.35 g/cm³.

The size of the film layer in the electrode plate was as follows: the length of the positive electrode active material layer was 544.3 mm, the width of the positive electrode active material layer was 118.7 mm, and the length of the negative electrode film layer was 546.8 mm, and the width of the negative electrode film layer was 119.9 mm.

### Example 5

A preparation method in the Example 5 was basically the same as that in the Example 4, and the difference was in the preparation process of the positive electrode active material, specifically,
adjusting the preparation method for the positive electrode plate, specifically adjusting the pressure, calendering speed, rolling time and rolling temperature in a rolling process to control the slurry coating thickness so as to obtain the positive electrode plate with the single-side thickness of the positive electrode film layer being 90.14 μm and the compaction density being 2.35 g/cm³.

### Contrast Example 1

A preparation method in the contrast example was basically the same as that in the Example 3, and the difference was in the preparation process of the positive electrode active material, the preparation process of the positive electrode plate and the size of the film layer in the electrode plate, specifically,
the difference in the preparation process of the positive electrode active material was as follows:
mixing the first abrasive and the second abrasive according to the mass ratio of 10:90 to obtain a mixed intermediate product; and performing spray drying on the mixed intermediate product; and
the difference in the preparation process of the positive electrode plate was as follows:
adjusting the preparation method for the positive electrode plate, specifically adjusting the pressure, calendering speed, rolling time and rolling temperature in a rolling process to control the slurry coating thickness so as to obtain the positive electrode plate with the single-side thickness of the positive electrode film layer being 105.62 μm and the compaction density being 2.35 g/cm³.

The size of the film layer in the electrode plate was as follows: the length of the positive electrode active material layer was 544.3 mm, the width of the positive electrode active material layer was 118.7 mm, and the length of the negative electrode film layer was 548.8 mm, and the width of the negative electrode film layer was 120.3 mm.

### Contrast Example 2

A preparation method in the contrast example was basically the same as that in the Example 2, and the difference was in the preparation process of the positive electrode active material, the preparation process of the positive electrode plate and the size of the film layer in the electrode plate, specifically,
mixing the first abrasive and the second abrasive according to the mass ratio of 90:10 to obtain a mixed intermediate product; and performing spray drying on the mixed intermediate product; and
the difference in the preparation process of the positive electrode plate was as follows:
adjusting the preparation method for the positive electrode plate, specifically adjusting the pressure, calendering speed, rolling time and rolling temperature in a rolling process to control the slurry coating thickness so as to obtain the positive electrode plate with the single-side thickness of the positive electrode film layer being 91.23 m and the compaction density being 2.35 g/cm³.

The size of the film layer in the electrode plate was as follows: the length of the positive electrode active material layer was 544.3 mm, the width of the positive electrode active material layer was 118.7 mm, and the length of the negative electrode film layer was 550.8 mm, and the width of the negative electrode film layer was 120.3 mm.

### Contrast Example 3

A preparation method in the Contrast Example 3 was basically the same as that in the Example 1, and the difference was in the preparation process of the positive electrode active material, the preparation process of the positive electrode plate and the size of the film layer in the electrode plate, specifically,
the difference in the preparation process of the positive electrode active material was as follows:
grinding the second abrasive by sand mill for 4 h at a frequency of 25 Hz, controlling the slurry temperature to be lower than 40 °C in the grinding process, and obtaining second grinding slurry, and the particle size Dv50 of solid particles in the second grinding slurry being 1.8 μm; and mixing the first grinding slurry and the second grinding slurry according to the mass ratio of 60:40, and performing spray drying to obtain mixed precursor powder;
the difference in the preparation process of the positive electrode plate was as follows:
adjusting the preparation method for the positive electrode plate, specifically adjusting the pressure, calendering speed, rolling time and rolling temperature in a rolling process to control the slurry coating thickness so as to obtain the positive electrode plate with the single-side thickness of the positive electrode film layer being 106.21 μm and the compaction density being 2.35 g/cm³.

The size of the film layer in the electrode plate was as follows: the length of the positive electrode active material layer was 544.3 mm, the width of the positive electrode active material layer was 118.7 mm, and the length of the negative electrode film layer was 550.8 mm, and the width of the negative electrode film layer was 120.3 mm.

### Test Method

### 1. Capacity of Battery Cell

At 25 °C, the battery cell was charged to be 3.65 V at a charging rate of 0.5 C of the nominal capacity of the battery cell, then was charged to 0.05 C at a constant voltage of 3.65 V, stood for 10 min, then was discharged to 2.5 V at a discharging rate of 1 C, and stood for 10 min; and the capacity C in the discharging process was calculated with a formula C=I×t, followed by the unit of Ah.

### 2. 60 °C Floating-Charge Lithium Precipitation Test for Battery Cell

The battery cell was placed in a constant-temperature box at 60 °C for 24 h until the battery temperature reached 60 °C; after the battery cell was charged to be 3.8 V at a constant current of 0.1 C, the battery cell was charged at constant voltage of 3.8V, timing was started, and it maintained for 336 h under this the voltage;
after charging, the battery cell was disassembled, the negative electrode plate was taken out, the negative electrode plate was golden yellow, if gray white, silver and brown spots appeared, it was determined that it was a lithium precipitation region, and the lithium precipitation area was measured;
if the maximum diameter in the spots of the lithium precipitation region was smaller than or equal to 5 mm or the total area of the lithium precipitation region was smaller than or equal to 2% based on the total area of the negative electrode film layer, it was determined to be slight lithium precipitation; and if the maximum diameter in the spots of the lithium precipitation region was greater than 5 mm and a sum of the area of the lithium precipitation region accounted for greater than 2% based on the total area of the negative electrode film layer, it was determined to be serious lithium precipitation.

### Test Results

The test results of the above examples and contrast examples are shown in Table 1-Table 2.

TABLE 1

| | Positive electrode plate | | | | | |
|---|---|---|---|---|---|---|
| | | | | Based on the | | |
| | | | | total area of | | |
| | | Based on the | | the particles | | |
| | | total area of | | in the section | | |
| | | particles in the | | of each | | |
| | | section of the | In the section | positive | | |
| | | positive | surface of the | electrode | | |
| | | electrode | positive | active | | |
| | | active material | electrode | material | | |
| | | layer along the | active material | layer along | When the | |
| | | thickness | layer along the | the thickness | battery cell | |
| | | direction of the | thickness | direction of | is in a full- | |
| | | battery cell, | direction of | the battery | discharge | |
| | Single- | the area | the battery | cell, the area | state, | |
| | side | proportion of | cell, L_{A}50 in | proportion of | compaction | |
| | thickness | particles with | the cumulative | the particles | density of | |
| | H of main | particle size | distribution | with the | the positive | |
| | body | R1 meeting | curve of | particle size | electrode | |
| | region | 50 nm ≤ R1 ≤ | sphericity area | R2 meeting | plate | Aluminum |
| | (μm) | 400 nm | of the particles | R2 > 1000 nm | (g/cm³) | leaks or not |
| Example | 105.76 | 32.74% | 0.62 | 14.45% | 2.34 | No |
| 1 | | | | | | |
| Example | 105.89 | 20.31% | 0.75 | 27.64% | 2.34 | No |
| 2 | | | | | | |
| Example | 106.42 | 14.67% | 0.72 | 36.53% | 2.36 | Yes |
| 3 | | | | | | |
| Example | 126.51 | 29.15% | 0.62 | 30.02% | 2.35 | No |
| 4 | | | | | | |
| Example | 90.14 | 28.77% | 0.61 | 31.42% | 2.35 | No |
| 5 | | | | | | |
| Contrast | 105.62 | 8.03% | 0.72 | 37.89% | 2.35 | Yes |
| Example | | | | | | |
| 1 | | | | | | |
| Contrast | 91.23 | 36.81% | 0.71 | 25.43% | 2.35 | Yes |
| Example | | | | | | |
| 2 | | | | | | |
| Contrast | 106.21 | 14.11% | 0.57 | 27.52% | 2.35 | Yes |
| Example | | | | | | |
| 3 | | | | | | |

| | Size difference between | | |
|---|---|---|---|
| | negative electrode film | | |
| | layer and positive | | |
| | electrode active material | | |
| | layer along the length | Battery | |
| | direction of the battery | | 60 °C floating- |
| | cell | | charge lithium |
| | (mm) | Capacity (Ah) | precipitation test |
| Example | 5.5 | 161 | No |
| 1 | | | |
| Example | 2.5 | 160 | No |
| 2 | | | |
| Example | 6.5 | 160 | No |
| 3 | | | |
| Example | 2.5 | 187 | Little lithium |
| 4 | | | precipitation |
| Example | 2.5 | 139 | No |
| 5 | | | |
| Contrast | 4.5 | 134 | Serious lithium |
| Example | | | precipitation |
| 1 | | | |
| Contrast | 6.5 | 136 | Serious lithium |
| Example | | | precipitation |
| 2 | | | |
| Contrast | 6.5 | 157 | Serious lithium |
| Example | | | precipitation |
| 3 | | | |

According to the examples and the contrast examples, the battery cell includes the stacked type cell, and the stacked type cell includes the positive electrode plate, the separator and the negative electrode plate which are sequentially stacked; the positive electrode plate includes the positive electrode current collector main body part, the positive electrode tab and the positive electrode active material layers; the positive electrode active material layers are arranged on two sides of the positive electrode current collector main body part along the thickness direction of the battery cell; the positive electrode tab is arranged on at least one side of the positive electrode current collector main body part; each positive electrode active material layer includes the main body region, and the thinned region arranged on the side, close to the positive electrode tab, of the main body region; the thickness of each thinned region is less than that of each main body region; each positive electrode active material layer includes the positive electrode active material; each positive electrode active material includes the lithium-containing transition metal phosphate particles of which at least part of surfaces are provided with a carbon material; when the battery cell is in the full-discharge state, the single-side thickness H of each positive electrode active material layer is 70-120 m; the area proportion of the particles with the particle size R1 meeting 50 nm≤R1≤400 nm is 10.0%-35.0% based on the total area of particles in the section of each positive electrode active material layer along the thickness direction of the battery cell; and in the section of each positive electrode active material layer along the thickness direction of the battery cell, L_{A}50 in the cumulative distribution curve of sphericity area of the particles is 0.6-0.8; and therefore, the problems of leakage of the current collector and lithium precipitation of the thick-coated battery cell are solved, and the cycle life and safety performance are ensured while high capacity is achieved.

According to the comparison between the Example 3 and the Examples 1-2, the area proportion of the particles with the particle size R2 meeting R2≥1000 nm is 12%-30% based on the total area of the particles in the section of each positive electrode active material layer along the thickness direction of the battery cell, which is conducive to reducing alignment deviation, relieving aluminum leakage of the electrode plates, and improving the cycle performance of the battery cell.

According to the comparison between the Example 3 and the Contrast Example 1, although there is aluminum leakage in the Example 3, the degree of aluminum leakage in Example 3 is smaller than that in the contrast example, and there is only a little aluminum leakage. Further, according to the comparison between the Example 3 and the Contrast Example 1, the size difference between the negative electrode film layer and the positive electrode active material layer in the length direction is small, which will aggravate the risk of lithium precipitation, on the contrary, if a larger region is reserved, the lithium precipitation can be resolved to a certain extent, it is presumed that it is because the expansion and deformation of the electrode plate in the cycle process intensifies, and the bonding force between stacked layers is poor, which can easily lead to position movement between the positive electrode plate and negative electrode plate, resulting in insufficient positions on the negative electrode side to accept ions escaped from the positive electrode side, resulting in lithium precipitation. According to the comparison between the Example 3 and the Contrast Example 3, in the section of each positive electrode active material layer along the thickness direction of the battery cell, L_{A}50 in the cumulative distribution curve of sphericity area of the particles is 0.6-0.8, which is conducive to reduce the degree of lithium precipitation, thereby relieving lithium precipitation of the electrode plate, and improving the cycle performance of the battery cell.

According to the comparison between the Examples 1-3, the Example 5 and the Example 4, the single-side thickness of the main body region is increased, namely the single-side surface density of the positive electrode active material layers is increased, which is conducive to improving the capacity of the battery cell. However, as shown in the Example 4 and the Example 5, under the condition of thick coating, if the size difference reserved between the negative electrode film layer and the positive electrode film layer in the length direction is smaller, lithium precipitation will occur even if the positive electrode plate manufactured by coating does not have aluminum leakage. Thus, the single-side thickness of the main body region is within the range of 100-120 m, which is conducive to relieving lithium precipitation of the electrode plates while ensuring the capacity of the battery, thereby ensuring the cycle performance and safety performance of the battery cell.

It is be noted that the present application is not limited to the above embodiments. The above embodiments are only examples, and embodiments that have the same composition and exert the same effect as the technical ideas within the scope of the technical solution of the present application are included in the technical scope of the present application. In addition, other methods that apply various deformations that can be conceived by those skilled in the art to the examples and construct them by combining some of the constituent elements of the embodiments are also included in the scope of the present application, within the scope of the application that do not deviate from the main purpose of the present application.

What is claimed is:

1. A battery cell, comprising a stacked type cell, wherein the stacked type cell comprises a positive electrode plate, a separator and a negative electrode plate which are sequentially stacked; and, wherein
the positive electrode plate comprises a positive electrode current collector main body part, a positive electrode tab and positive electrode active material layers; the positive electrode active material layers are arranged on two sides of the positive electrode current collector main body part along a thickness direction of the battery cell; the positive electrode tab is arranged on at least one side of the positive electrode current collector main body part, wherein
each positive electrode active material layer comprises a main body region, and a thinned region arranged on the side, close to the positive electrode tab, of the main body region; a thickness of each thinned region is less than that of each main body region;
each positive electrode active material layer comprises a positive electrode active material; each positive electrode active material comprises lithium-containing transition metal phosphate particles of which at least part of surfaces are provided with a carbon material;
when the battery cell is in a full-discharge state, a single-side thickness H of the main body region is 70-120 μm;
an area proportion of particles with a particle size R1 meeting 50 nm≤R1≤400 nm is 10.0%-35.0% based on a total area of particles in a section of each positive electrode active material layer along the thickness direction of the battery cell; and
in the section of each positive electrode active material layer along the thickness direction of the battery cell, L_{A}50 in a cumulative distribution curve of sphericity area of the particles is 0.6-0.8.

2. The battery cell according to claim 1, wherein when the battery cell is in the full-discharge state, the single-side thickness H of the main body region is 90-120 μm.

3. The battery cell according to claim 1, wherein in the section of each positive electrode active material layer along the thickness direction of the battery cell, L_{A}50 in the cumulative distribution curve of sphericity area of the particles is 0.65-0.75.

4. The battery cell according to claim 1, wherein projections of edges, far away from the main body regions, of two thinned regions on two sides of the positive electrode current collector main body part in the thickness direction of the battery cell on the positive electrode current collector main body part are A and B respectively, and the minimum distance E from A to B is 0.1-0.6 mm.

5. The battery cell according to claim 1, wherein the area proportion of particles with a particle size R2 meeting R2≥1000 nm is 12%-30% based on the total area of the particles in the section of each positive electrode active material layer along the thickness direction of the battery cell.

6. The battery cell according to claim 1, wherein in the section of each positive electrode active material layer along the thickness direction of the battery cell, a distribution uniformity of the particles with the particle size R2 meeting R2≥1000 nm is less than and equal to 5.0%.

7. The battery cell according to claim 1, wherein each positive electrode active material layer further comprises a binder, and the binder comprises a dispersant which comprises hydrogenated nitrile butadiene rubber (HNBR); and/or, based on a total mass of the positive electrode active material layers, a mass content of the dispersant is 0.5%-2%.

8. The battery cell according to claim 1, wherein the positive electrode active material layer further comprises a conductive agent, and based on the total area of the positive electrode active material layers along the thickness direction of the battery cell, the area proportion of an agglomeration region of the conductive agent is 0.5%-20.5%, wherein
the conductive agent comprises carbon nanotubes which comprise one or more of a single-walled carbon nanotube, a few-walled carbon nanotube and a multi-walled carbon nanotube; and
the agglomeration region of the conductive agent comprises carbon nanotubes and conductive carbon black, wherein based on a total mass of the positive electrode active material layers, a mass content C1 of a carbon nanotubes meets: 0<C1≤2.5%, and a mass content C2 of the conductive carbon black meets: 0<C2≤2.5%.

9. The battery cell according to claim 1, wherein when the battery cell is in the full-discharge state, a single-side surface density of the positive electrode active material layers is 0.25 g/1540.25 mm²-0.45 g/1540.25 mm², wherein when the battery cell is in the full-discharge state, a compaction density of the positive electrode plate is 2.3 g/cm³-2.6 g/cm³.

10. The battery cell according to claim 1, wherein the positive electrode plate further comprises an insulating layer which is arranged on one side, far away from the main body region, of the thinned region, wherein
the insulating layer comprises a metal oxide; and
the negative electrode plate comprises a negative electrode current collector, and a negative electrode film layer arranged on at least one side of the negative electrode current collector; and in the thickness direction of the battery cell, a projection edge of the negative electrode film layer is on an outer side of the insulating layer, wherein a size difference between the negative electrode film layer and the positive electrode active material layers in a length direction of the battery cell is 4-16 mm, and the size difference between the negative electrode film layer and the positive electrode active material layers in a width direction of the battery cell is 1-5 mm.

11. The battery cell according to claim 1, wherein the positive electrode tab is arranged on at least one end, extending along the length direction of the battery cell, of the positive electrode current collector main body part.

12. The battery cell according to claim 1, wherein the positive electrode tab is arranged on at least one end, extending along the width direction of the battery cell, of the positive electrode current collector main body part.

13. The battery cell according to claim 1, wherein the separator comprises a base film, ceramic layers arranged on two sides of the base film, and binding layers arranged on the sides, far away from the base film, of the ceramic layers; the binding layers are continuous layers of a porous structure; and the binding layers comprise a vinylidene fluoride polymer; and, wherein
the separator meets at least one of the following conditions:
(1) the thickness of the base film is 7-9 μm;
(2) the single-side thickness of the ceramic layers is 2-4 μm; and
(3) the single-side thickness of the binding layers is 1-5 μm.

14. The battery cell according to claim 1, wherein a primer is arranged in a bottom region, close to the positive electrode current collector, of each positive electrode active material layer, and the primer meets at least one of the following conditions:
(1) the primer comprises a conductive agent and a binder, in which, the conductive agent comprises carbon nanotubes and conductive carbon black, and the binder comprises a vinylidene fluoride polymer; and
(2) the thickness of the primer is 0.5 μm-5 μm.

15. The battery cell according to claim 1, wherein the positive electrode plates and the negative electrode plates are alternately stacked along the thickness direction of the battery cell; the separator forms a continuous spiral structure or a continuous “Z”-shaped structure; the separator is arranged between an adjacent positive electrode plate and negative electrode plate in a penetrating manner to separate the adjacent positive electrode plate and negative electrode plate.

16. The battery cell according to claim 1, wherein
the battery cell also comprises a case in which the stacked type cell is accommodated; and the material of the case is a pouch material which comprises an aluminum-plastic composite film; and/or
the size of the case in a length direction is L1, the size of the case in a width direction is W1, the size of the case in a thickness direction is H₁, in which, 450 mm≤L₁≤1300 mm, 100 mm≤W₁≤150 mm, and 14 mm≤H₁≤22 mm, wherein
the size of the case in the length direction is L1, 450 mm≤L₁≤650 mm; and
the size of the case in the length direction is L1, 900 mm≤L₁≤1300 mm.

17. The battery cell according to claim 1, wherein the lithium-containing transition metal phosphate particles comprise components shown in the following general formula:
LiₘFeₓP_{y}OⱼQ_{q} Formula I,
in which, Q comprises one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

18. A battery apparatus, comprising the battery cell according to claim 1.

19. The battery apparatus according to claim 18, further comprising a box body, wherein a plurality of battery cells are stacked in rows along the thickness direction and are arranged in the box body in a binding way; a reinforcement baffle is arranged between large surfaces of a cases of two adjacent battery cells and is connected to the box body, and a rigidity of the reinforcement baffle is larger than the rigidity of a case of the battery cells, wherein two reinforcement baffles which are arranged in an adjacent way along the thickness direction and are arranged on two sides of at least one battery cell in the thickness direction are connected by a connection plate arranged at a peripheral region of the battery cell, wherein the connection plate is arranged between the two connected reinforcement, the two connected reinforcement baffles are integrally connected to form a U-shaped case.

20. An electrical apparatus, comprising the battery apparatus according to claim 18, wherein the battery apparatus is configured to provide electric energy.
